(19) United States
(12) Patent Application Publication
(10) Pub. No.: US 2006/0200772 A1
(43) Pub. Date: Sep. 7, 2006

(54) Procedural computation engine for providing complex calculated data results to an object-oriented server system accessible to service clients and agents over a data packet network

(76) Inventors: Sathiyamoorthy Dhanapal, Kancheepuram (IN); Suresh Sabapathy Sambandam, Saidapet (IN); Sanjay Mittal, Fremont, CA (US); Sam Peter Hamilton, Sunnyvale, CA (US)

Correspondence Address: CENTRAL COAST PATENT AGENCY, PO BOX 187, AROMAS, CA, 95004, US

(21) Appl. No.: 10/731,047

(22) Filed: Dec. 8, 2003

(51) Int. Cl. G06F 17/00; G06F 9/44

(52) U.S. Cl. 715/760; 717/100

(57) ABSTRACT

A procedural computation engine is provided for generating and serving executable high-level code. The engine includes a Graphical User Interface for creating procedural computation schemas; a parser for interpreting output from the Graphical User Interface; a compilation component for hierarchal node-structuring of data; and a server component for providing access to generated information. A programmer operating through the Graphical User Interface pre-creates at least one procedural computation schema including the algorithmic function or functions and input needed to produce computational results, the data of the schema output as a markup file interpreted by the parser and in cooperation with the compilation component generates an executable computation model accessible and executable through the server component. In one embodiment the engine is used to provide complex rating information.

### FIELD OF THE INVENTION

The present invention is in the field of e-commerce including transaction handling and rate calculation and pertains particularly to a method and apparatus for providing automated rating services associated with such services as insurance to candidate and existing clients of an enterprise.

### BACKGROUND OF THE INVENTION

In the field of e-business that is, business conducted between two or more parties over a data packet network connection, there are a number of software pricing systems for enabling self service to users who purchase products or services from companies over a network like the Internet network for example. Most of these services are relatively simple and involve interactive order forms and database functionality to provide order processing. Pricing is generally known ahead of time and published to clients. All a client has to do is fill out a simple form and submit the form to initiate a purchase and receive a confirmation of the purchase.

More recently, systems have become available for enabling clients to make more complex purchases under more complex pricing schemas. These systems typically use a rules based configuration engine with a connection to a database to perform order and pricing configuration. In this scheme there are typically different pricing options that are tailored to differing types or classes of clients. Rules-based configurators are not physically separated from the actual data to be configured and are somewhat inflexible. Pricing systems that manage data tables and product/sales hierarchies are also somewhat inflexible and process intensive.

With the advent of object orientation, it has occurred to the inventors that much automation and much more flexibility with respect to complex pricing schemes for different order and client classes can be obtained in a fashion that is multi-user accessible and platform independent. For example, using Knowledge Base (KB) technologies and object building software, the inventors have done much to improve flexibility and efficiency of conducting on-line business transactions.

The inventors are aware of a multi-platform and language capable KB configurator referenced via IDS filed with this patent application. The system generates KB models reflecting user order parameters and can be accessed over a network by users through fat or thin clients operating a client plug-in module. Files are transferred over network lines as ASCII files termed “flat files” in order to conserve bandwidth so light clients on such as hand-held devices plugged into the network can be used to configure and place orders. Further development and enhancement by the inventors has resulted in a capability for submitting changes or modifications to a KB configuration without requiring download of the KB or software to manipulate the KB. The technology uses one of a variety of universal object modeling languages like C++ or Java to implement the KB.

The inventors are also aware of an object-oriented pricing system that is constraint-based and selectively fires specific rules in order to provide correct and accurate pricing to users according to a complex pricing model that covers many forms of pricing and discounting schemas tailored for a wide variety of client classes and channels. This system uses rule comparison and modular pricing algorithms in order to calculate correct pricing arrangements for clients before orders are placed. The system also can be used to apply correct pricing for multiple products and bundled services under differing pricing schemas to clients during a real time transaction.

Although the inventor has contributed largely to the art, the systems described above are not capable of providing very complex rating information such as may be used to calculate complex pricing for services like medial insurance and other types of insurance coverage where final rates that must be calculated depend on accounting of many variables and client attributes and even state mandated rules.

State-of-art tools for enabling insurance agents, brokers, underwriters, actuaries, and the like to perform their stated functions are still largely manually operated and subject to much delay, human review, re-calculation procedures, and so on. Moreover there are numerous sectors involved in the insurance process like new business rating, renewal rating, claims adjustment, and service upgrade or change re-rating, as well as many tier levels of service that take into account employee numbers, employee states, corporate structure, corporate size, and corporate activity states, local laws, and so on before final accurate and verified service rating can be performed and distributed for fulfillment.

In current art, business users in various industries use spreadsheet type applications to perform very complex business calculations. For example, in the insurance industry, actuaries use spreadsheets to perform complex analyses. The use of spreadsheet applications provide a quick easy and usable interface for such complex computations. However, the capabilities of these applications suffer from the serious limitation of being unable to scale up to the needs of large enterprises. For example, the use of such applications in a complex rating environment like insurance services fulfillment requires much manual collection aggregation and input of many variables as well as review of business rules and practices. For an enterprise with a large demand the overall process is very process intensive and involves many players from the point of view of manual tasking. Moreover, as spreadsheet programs are notoriously common desktop tools, the business logic of the enterprise ends up being distributed to all the enterprise personnel performing contributory tasks. At the enterprise level, this arrangement does not provide for any central control or security.

What is clearly needed is an automated procedural computation engine that can be used to develop and deploy complex rating models into a server architecture for use in automated rate calculation for complex services like insurance quoting and fulfillment according to client needs and reported states considered, and real-time requirements.

### SUMMARY OF THE INVENTION

In a preferred embodiment of the present invention a procedural computation engine for generating and serving executable high-level code is provided, comprising a Graphical User Interface (GUI) for creating procedural computation schemas, a parser for interpreting output from the Graphical User Interface, a compilation component for hierarchal node-structuring of data, and a server component for providing access to generated information The engine is characterized in that a programmer operating through the Graphical User Interface pre-creates at least one procedural computation schema including the algorithmic function or functions and input needed to produce computational results, the data of the schema output as a markup file interpreted by the parser and in cooperation with the compilation component generates an executable computation model accessible and executable through the server component.

In a preferred embodiment the Graphical User Interface is of the form of an interactive spreadsheet processing application and the computation model is a rating model. Also in a preferred embodiment the parser is adapted to read XML and to write in Java Document Object Model structure. Also in a preferred embodiment the compilation component includes a lexical scanner and a code generator.

In some embodiments the computation models are rate models pre-stored for access by the server component upon request over a network connection. In other embodiments the model is a rate model designated as a user function to be embedded in another rate model. In still other embodiments the computation models are rate models and a knowledgebase configurator has access to the stored rate models through one of remote method invocation or through remote call procedure over a network connection.

In some cases the network connection is one of an Internet or an Intranet connection. Also in some cases the network connection is one of an Internet or an Intranet connection. In still other cases the processing application can interpret Extensible Markup Language and can save data in the form of Extensible Markup Language.

In another aspect of the invention a rating service is provided comprising a procedural computation engine having a graphical user interface for creating procedural rating schemas, a parser for interpreting output from the graphical user interface, a compilation component for hierarchal node-structuring of data; and a server component for providing access to generated information, a knowledgebase configurator for configuring service requests, and a software interface application through which requests for rating are submitted. The rating service is characterized in that an end user accesses the configurator through the interface application and submits parameters for configuration of a service request whereupon the configurator calls the server component of the computation engine and selects a rate model from a pool of rate models that fits the request parameters, the rate model applied to and executed within the configuration model to produce the rating results through the application interface.

In some preferred embodiments the software interface application is an insurance application suite. In some other preferred embodiments the parser is adapted to read XML and to write in Java Document Object Model structure. In still other preferred embodiments the configurator is a Web-based configurator and calls the server component of the computation engine using one of remote method invocation or remote call procedure.

In some embodiments a service configuration contains more than one rate model, the models individually executed according to optional scenarios. In some other embodiments a service configuration contains more than one rate model, one rate model designated as a user function embedded in another rate model. In still other embodiments the rating service is integrated with a software framework for enabling client security verification, user interface generation, workflow management, database search functionality, and language transformation for presentation to alternate platforms and interfaces.

In yet another aspect of the invention a method for modeling a procedural rating schema is provided, comprising steps of (a) using a spreadsheet interface, inputting at last one algorithm or formula into a specific cell or cells for rate calculation; (b) in the same interface, entering the required input values into cells and marking the cells that will carry the input values into the calculation; (c) in the same interface, marking the cell or cells that will show the output results from the calculation; and (d) saving the data as a rating computation file in Extensible Markup Language.

In a preferred embodiment of this method in step (a) the spreadsheet calculation functionality includes one or more calculation functions Loop Add, Loop Multiply, Loop And, Loop Or, and Loop Append. In another preferred embodiment a step between step (a) and step (b) is added for inputting optional parameters for optional executions according to the differing parameters.

In yet another aspect a method for compiling a rate model from a rate computation file created and saved in Extensible Markup Language is provided, comprising (a) parsing the file in a parser; (b) building a symbol table from parsed elements; (c) outputting a Java Document Object Model file from the parser; (d) building a syntax tree from the Java Document Object Model file; (e) validating the hierarchy of the syntax tree; (f) generating model code for executing the file; and (g) outputting the executable component.

In some preferred embodiments in step (a) the parser reads Extensible Markup Language and writes Java Document Object Model language. In some other preferred embodiments step (b) is referenced when step (d) is executing to access symbols from the symbol table. In still others there is a step included between step (e) and step (f) for optimizing the built hierarchy. In still other embodiments there is a step between step (f) and step (g) for compiling the data into alternate object model languages for presentation across platforms.

In some cases in step (a) the spreadsheet calculation functionality includes XML operation functions get value and set value. In some other cases in step (d) the source node of the tree is a formula node with a condition variable of true or false. In still other cases variables are scoped using block translation according to the condition type of true or false. In yet other cases the compilation component includes at least one block translator for scoping variables, and in some others the compilation component creates loop constructs to resolve variables in the case of a dynamic query, the loop calculations performed to create a formula.

### BRIEF DESCRIPTION OF THE DRAWING FIGURES

FIG. 1 is an architectural overview of a system for calculating rates, configuring services, and fulfillment of services according to an embodiment of the present invention.

FIG. 2 is a block diagram illustrating modules of an insurance suite and their hierarchy with respect to supporting foundation services according to an embodiment of the present invention.

FIG. 3 is a block diagram illustrating foundation services 201 of FIG. 2 in further detail.

FIG. 4 is a block diagram illustrating UI generation within the presentation layer of FIG. 3.

FIG. 5 is a block diagram illustrating function of DAAS of FIG. 3 according to an embodiment of the present invention

FIG. 6 is a block diagram illustrating internal function of the search module of FIG. 3.

FIG. 7 is a block diagram illustrating an authentication and authorization process enabled by the SAAS layer of FIG. 3.

FIG. 8 is an exemplary use-diagram 800 illustrating workflow generation and maintenance according to an embodiment of the present invention.

FIG. 9 is a block diagram illustrating internal components of the rating engine including its relationship with the configurator of FIG. 3.

FIG. 10 is a screen shot of an interface of the rate manager of FIG. 9 according to a preferred embodiment of the present invention.

FIG. 11 is a block diagram illustrating a function of creating an executable model from a computational model using the rate compiler of FIG. 9 according to a preferred embodiment of the present invention.

FIG. 12 is a screen shot of a data manager interface invoked from the rate manager interface of FIG. 10.

FIG. 13 is a screen shot of an interface invoked from the data manager interface of FIG. 12 illustrating query submission.

FIG. 14 is a screen shot of a rate manager result interface returned from the query submission of FIG. 13.

FIG. 15 is a screen shot of a rate manager interface revealing a first algorithm inserted as a function

FIG. 16 is a screen shot of a rate manager interface illustrating a second algorithm being inserted.

FIG. 17 is a screen shot of a rating parameters interface invoked from the rate manager interface of FIG. 10.

FIG. 18 is a screen shot of a rate model-testing interface.

FIG. 19 is a process flow diagram illustrating steps for compiling a JDOM executable component from an XML rate computation model according to an embodiment of the present invention.

FIG. 20 is a block diagram illustrating an exemplary Abstract Structure Tree (AST) node hierarchy 2000 produced through compiling and lexical analysis.

FIG. 21 is a block diagram illustrating resolution of variable scope issues.

FIG. 22 is a process flow diagram illustrating a block translation example according to an embodiment of the present invention.

### DESCRIPTION OF THE PREFERRED EMBODIMENTS

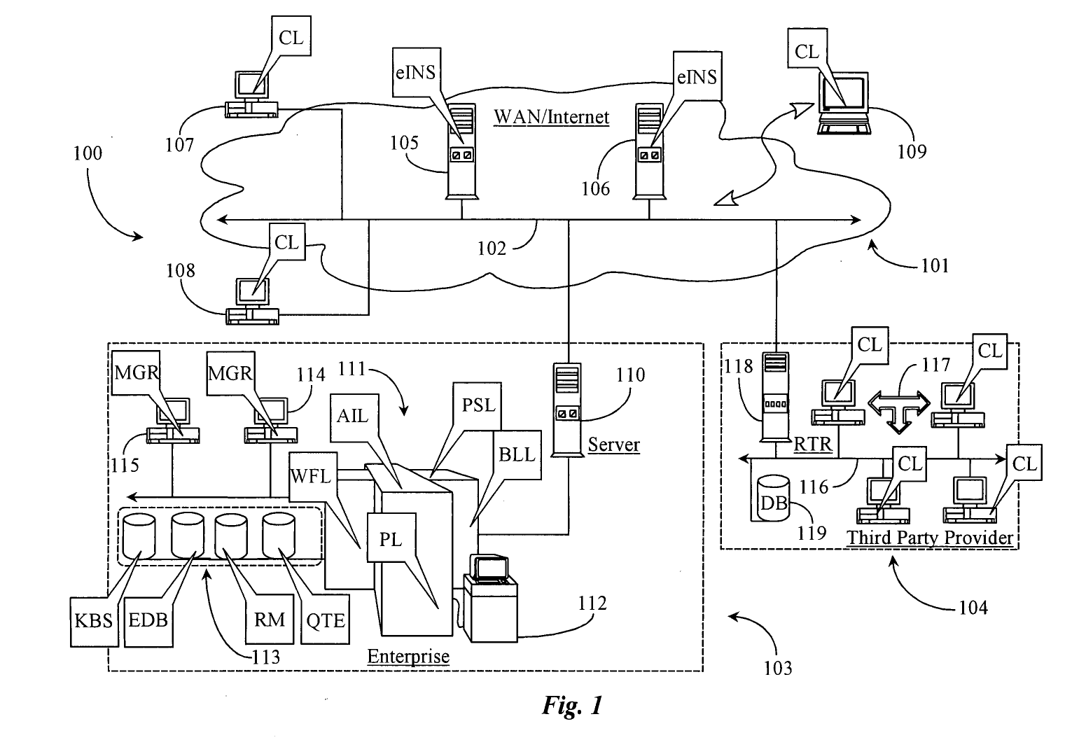

FIG. 1 is an architectural overview of a system 100 for calculating rates, configuring services, and fulfillment of services according to an embodiment of the present invention. System 100 is an object-oriented system that is accessible through a wide-area-network (WAN) such as the well-known Internet network represented herein as WAN/Internet 101. Internet 101 can be another type of WAN network without departing from the spirit and scope of the present invention. For example, network 101 can be an Intranet network, an Ethernet network, or a combination of sub networks having connection to the Internet network.

The software and architecture of the present invention is hosted from within an enterprise 103 in this example. Enterprise 103 is typically any type of enterprise through which complex services like insurance services are provided to a large clientele. In this example, enterprise 103 may be thought of as a very large corporate entity that provides a variety of services and/or products to other businesses and/or individual users.

Enterprise 103 has a mainframe computing system 111 illustrated therein and adapted, in this example, as a machine host adapted to support several enterprise business-software layers referred to collectively herein as foundation services. The software termed foundation services may also be distributed instead to a number of connected server and repository components in a distributed architecture. Illustration of mainframe 111 as a main machine host is for explanatory purpose only and to provide one example of a hardware component or system that can host the software of the invention.

Mainframe 111 has an administration-control station connected thereto by way of a network data cable. Control station 112 is responsible for maintenance and other functional issues of mainframe 111 as is generally known of such hardware configurations. Mainframe 111 has a plurality of repositories connected thereto illustrated collectively herein as repositories 113. Repositories 113 comprise data stores that are specialized for holding certain types of data used by the software of the invention. In a preferred embodiment, repositories 113 are object-oriented or relational databases and are Java enabled. Repositories 113 include at least a quote (QTE) repository, a rate model (RM) repository, an enterprise database (EDB), and a knowledge base system (KBS).

Mainframe 111 supports foundation services configured as integrated software layers that together provide all of the services necessary to implement complete rating, quoting, and fulfillment of, in this case, business insurance services. At the core of foundation services architecture is a business logic layer (BLL) that provides all of the business logic necessary for providing calculated result data for use in configuring insurance proposals for candidate and existing clients.

A persistence layer (PL) is provided as part of the foundation services for enabling applications automated and human-directed access to stored data for rate calculation, data mining, model building, data manipulation, and database searching of repositories 113. Objects are mapped to tuples stored in data repositories 113 using an OO/ER mapping schema. A data workflow layer (WFL) is provided for the purpose of defining and maintaining modeled processes and workflow synergy between different users. An application integration layer (AIL) is provided for enabling application-to-application integration and additionally to provide adapters to external systems.

A final software layer of foundation services is a presentation layer (PSL) provided for development and deployment of user interface (UI) functionality including capture of presentation views, model views, workflow views, and returned results containing rating information and service configurations. A core component of the foundation services is a procedural computation engine, also referred to herein as a rating engine, which cooperates with a service configuration engine (configurator) and rating server, which is embedded within the BLL and accessible through the PSL. These components will be illustrated in further detail later in this specification.

Enterprise 103 has a server 110 connected to mainframe 111 at one end and to the Internet network 101 at the other end. Server 110 is adapted to provide direct service access to external applications through AIL and PSL. Server 110 may perform some of the presentation duties such as language transformation from XML-based languages to those used by individual platforms. In some embodiments, server 110 may host the front-end services of the foundation layers like AIL, PSL, and service authentication. There are many variant architectural possibilities without departing from the spirit and scope of the present invention.

Mainframe 111 is connected to a local area network (LAN) 120 that supports a plurality of desktop workstations illustrated herein as workstation 114 and workstation 115. Workstations 114 and 115 are dedicated for the purpose of programming including object modeling, and object model versioning. There may be many more workstations dedicated to programming, model testing, model versioning and so on than are illustrated in this example. The inventor shows only two such stations and deems them sufficient for the purposes of explanation.

An instance of a rate manager (MGR) application is illustrated on each workstation 114 and 115. MGR is a programming tool used for creating rating models, writing algorithms, and providing the appropriate parameters required to generate executable rate models, which can be server deployed for later use. MGR is part of an enterprise rating-center (ERC) functionality and will be illustrated in more detail later in this specification.

It will be apparent to one with skill in the art of object representation in a business environment that there are many architectural variations possible with respect to software services and hardware components that host them. For example, in one embodiment data for rate calculation, client identification, and other service functions may be legacy-hosted data accessed through a middleware solution. In other embodiments, the data stores and software layers are distributed among a number of separate machines with access to Java Data Base Connectivity (JDBC) and/or Object Data Base Connectivity (ODBC) compliant databases.

Network 101, which is the Internet network in this example, has an Internet backbone 102 extending there through. Backbone 102 represents all of the lines equipment and access points that make up the Internet network as a whole including connected sub-networks. Therefore, there are no geographic limitations to the practice of the present invention.

Internet 101 has a plurality of network servers provided therein and shown connected to backbone 102. These are network servers 105 and 106 respectively. Servers 105 and 106 are, in this example, identical to each other serving as client interface servers for clients engaged in service relationships with enterprise 103. More than one interface server is shown to demonstrate scalability in that there may be more than one access server adapted to interface with clients of enterprise 103. Servers 105 and 106 are, in one embodiment, enterprise hosted servers that each support an insurance software suite labeled herein INS, adapted as a front end application suite that can be manipulated by users (clients and third parties) to initiate service fulfillment for insurance services like enrollment, renewal, quoting, underwriting, claims adjustment, among other service functions associated with insurance related business.

INS is a multi-module software suite that runs as an application software on top of the foundation services software platform within enterprise 103. In this case, enterprise 103 is a main provider of insurance services to a wide variety of clients including corporate clients and in some cases individual clients. Clients of enterprise 103 can access services through either server 105 or server 106. Clients are represented in this example as computer icons 107 and 108 having connection to backbone 102, Laptop icon 109 having a wireless connection to backbone 102 and a third party service provider 104 having a connection to backbone 102 through a server node 118.

Third Party Provider 104 can be a partner of enterprise 103 or a brokerage house set up for insurance sales and service, and may host one of servers 105 or 106. Third party provider 104 has a LAN network 116 provided therein and a plurality of connected workstations 117 adapted for the purpose of sales and service. It may be assumed that each station is manned with an insurance agent. A database 119 is provided and connected to LAN 116 for the purpose of storing information about products and clients of the third party. In this embodiment, enterprise 103 is the main provider and third party provider 104 interacts with enterprise 103 as would other direct clients. It is noted herein that there may be many co-branded partners of enterprise 103 without departing from the spirit and scope of the present invention. Likewise, any co-brand partner may host a server with an insurance suite wherein clients of the third party may receive automated rating information for quoting, and renewals just as direct clients to enterprise 103 would. It is also noted herein that there may be many remote users of the system hosted by enterprise 103 that provide contributory services such as claims analysis, underwriting, claims inspection, and the like. These users can access functionality through servers 105 or 106.

Clients and users alike have an instance of a client (CL) application installed on their accessing devices. For example, third party stations 117 all have client software instances installed. Likewise, desktops 107, 108, and Laptop 109 have client instances installed. In this case, the client instance enables users to interact with specific modules of INS hosted in servers 105 and 106. Client functionality may be realized through a browser plug-in module that enables interaction with certain smart forms that provide instruction to a service configurator that calls and receives rating information for service configuration and presentation. It is important also to note herein that there are typically many interactions, possibly involving external parties that will take place before a final acceptable rating for a business is quoted and finalized because of the complexity of the service involved.

In practice of the present invention, a client or third party broker initiates an action to the enterprise through server 105 or 106 for an insurance need. The appropriate modules of the INS suite are invoked and subsequent interaction includes form filling and other information gathering as may be required to gather all of the important variables and states for rating and quoting purposes. All clients and users may be required to pass an internal and, perhaps a third-party security authentication procedure before obtaining complete access to automated services. New clients may be validated and configured for repeat access with security mechanisms like passwords, login procedures or the like.

Once a client has access and has provided the required information to main service provider 103, a business process or processes related to the clients stated needs may begin. For example, a new business client, perhaps client 108 may want an estimate quoted for medical insurance for his company employees based on preliminary information such as approximate employee number and other like parameters. In this mode the client is shopping and may sample more than one product or service plan. When the information is submitted a quote model is instantiated the model reflecting the parameters of the client according to the selected service plan, the coverage amount or percentage requested, the types of coverage requested, whether or not prescription coverage is requested and so on. The quote model may include one or more rate models accessed from a pool of such models. A quote model may be saved and re-executed if a subsequent request for quotes has parameters that sufficiently match the saved model. The model can be modified or re-instantiated according to the exact parameters of the client and client selection to resolve any required modifications of attributes or objects. Therefore, a model generated for a specific plan with constraint ranges on employee numbers may be saved and then accessed and re-instantiated to reflect rates for the exact employee figure. More about the object models and hierarchies will be presented further below.

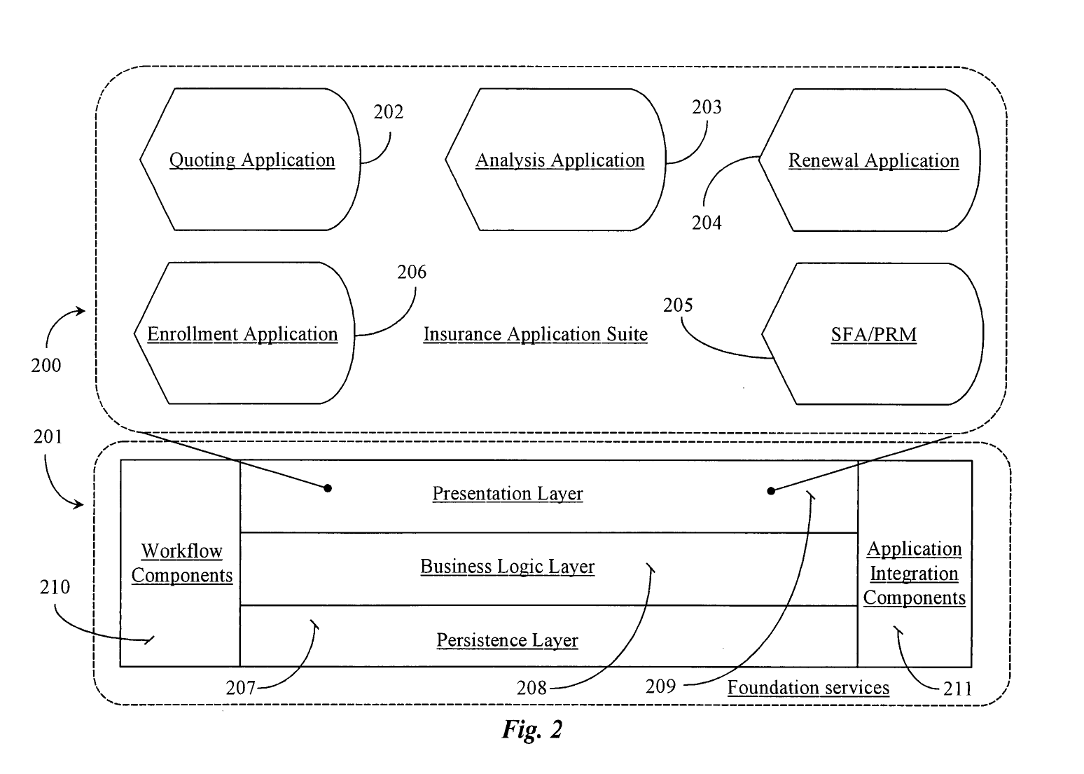

FIG. 2 is a block diagram illustrating modules 200 of an insurance suite and their hierarchy with respect to supporting foundation services according to an embodiment of the present invention.

Modules 200 comprise an insurance application suite identified above as INS with respect to the description of FIG. 1 above. In a preferred embodiment, suite 200 is server-based and accessible to users over the Internet, an Intranet, or any other suitable network combination Users may be direct clients or third-party brokers and other users that may provide contributory tasks.

Suite 200 has a quoting application 202 provided therein and adapted for the purpose of accessing instant quotes for specific insurance needs. An enrolment application 206 is provided within suite 200 and adapted for the purpose of initiating an enrollment process after agreeing to an insurance quote. An analysis application 203 is provided within suite 200 and is adapted to enable a user charged with the task to evaluate and analyze a proposal for enrollment. This may include data validation, underwriting processes, actuary functions and so on. In the case of an actuary, the application is used to invoke final rating for a complex insurance plan after risk assessment and other assessment functions. It is noted herein that risk assessment variables and other parameters that might influence a final rate model are instantiateable attributes of the rating model. The underwriter need only provide the arguments in the appropriate fields in the applications generated UI interface, which is in a preferred embodiment is an HTML Web form.

A renewal application 204 is provided within suite 200 and is adapted to enable clients and brokers to renew and revise existing insurance plans that are in effect. A sales force automation (SFA)/partner relations management (PRM) module 205 is optionally provided within suite 200 and adapted for automating third-party users and partners for interaction with the rating capability of the system of the invention. Access may be governed by specific rules and regulations for brokers, third-party services, and the like that may be integrated with the system of the present invention.

A foundation of services (software layers) 201 is illustrated herein and is analogous to the software layers PSL, BLL, AIL, WFL, and PL described as foundation services software layers with respect to FIG. 1 above. These components will be formerly introduced herein with element numbers in addition to their labels of the example of FIG. 1.

A presentation layer 209 (PSL) is illustrated herein and adapted for presenting requests from suite 200 and for returning results to suite 200 and as generally described with reference to FIG. 1 above. A business Logic Layer 208 (BLL) is illustrated herein and performs the business rating and calculating as was described with reference to FIG. 1 above. A persistence layer 207 (PL) is illustrated herein and adapted for coordinating access to databases and data repositories as was generally described with reference to FIG. 1 above. An application integration layer 211 (AIL) is illustrated herein and contains application integration components and adapters to external system as was previously described above with reference to FIG. 1. A workflow layer 210 (WFL) is illustrated herein and adapted to manage the various business processes that occur within the system as was previously described with reference to FIG. 1 above.

In this example, it is represented that the applications of suite 200 interact with the rest of the system functionality directly through the presentation layer 209. This is true in most instances but it should not be construed as a limitation as in some instances access may be granted to users in certain circumstances to specific components of foundation services 201 if warranted and standard UI functionality is present at the accessing node. In other words, certain users such as programmers, system administrators, etc. may access specific components directly internally or from a remote location using tools other than suite 200 for the purpose of maintenance, programming, adding new functionality, and so on. It would follow that such users would be adapted with their own GUI-enabled tools to enable their stated functions.

It is noted herein that suite 200 is an insurance suite adapted to enable fulfillment of insurance needs, however this should not be construed as a limitation to the practice of the present invention. Other types of service fulfillment suites may also be provided that can use the rating functionality of the present invention. For example, rental companies, movers, mortgage companies, and other types of businesses where complex rating services are required can be represented as suite 200. Moreover, foundation services architecture 210 can be adapted to interact according to more than one disparate application suite using the appropriate data models, business object hierarchies and rating models separately for each type of business. The inventor illustrates an insurance suite as a best-use example of complex rating requirements that can be provided through foundation services 210.

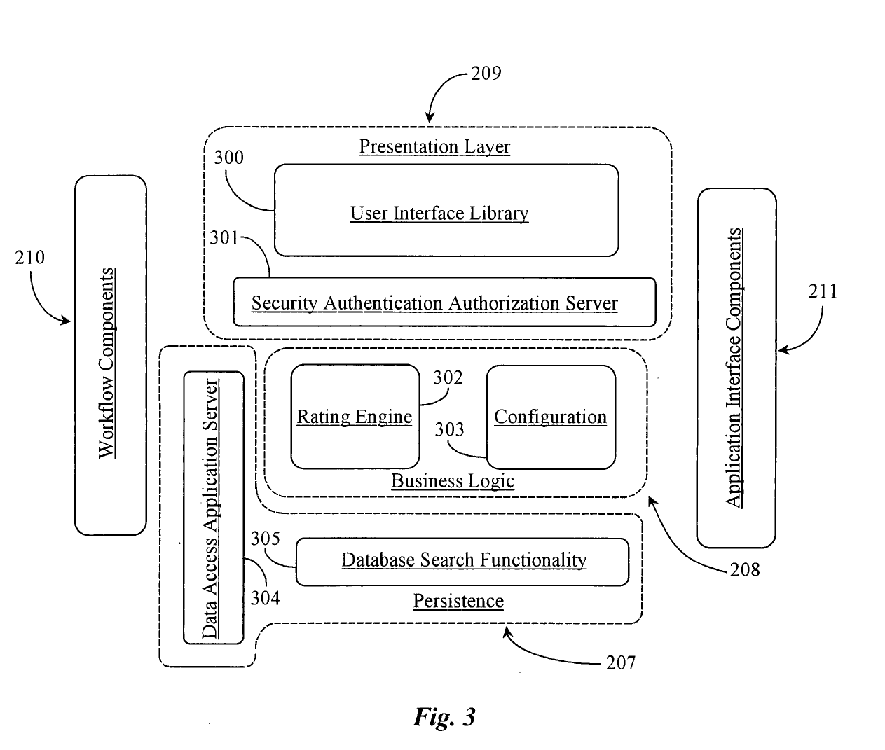

FIG. 3 is a block diagram illustrating foundation services 201 of FIG. 2 in further detail. As previously described, foundation services 201 includes presentation layer 209, business logic layer 208, persistence layer 207 workflow layer 210, and application integration layer 211.

In this example, layers 209, 208, and 207 are illustrated showing internal components. Within presentation layer 209 there is a user interface (UI) library 300 and a Security Authentication and Authorization Server (SAAS) 301. SAAS server 301 provides authentication services both from internal sources and third-party verification systems like Site minder™, for example, or similar known identification verification services. Such services typically use a secure socket layer (SSL) for communication. Internal database verification systems using passwords, codes, cookies, or other login protocols can also be implemented. In a preferred embodiment, both an external verification service and an internal identification protocol are employed.

UI library 300 contains all of the necessary XML-based code for generating user interfaces. In a preferred embodiment user interfaces are generated in Extensible Style Language (XSL), which is a specification for separating style from content when creating Hyper Text Markup Language (HTML) pages and Extensible Markup Language (XML) pages. XSL templates enable developers to separate style from content in an XML document thereby enabling the user to apply single style documents to multiple UI pages. XSL allows developers to dictate the way HTML pages are printed. XSL allows XML documents to be seamlessly transported across different applications.

Persistence layer 207 has a database search function module 305 provided therein and adapted to enable users to search for KBS model instances and other database tuples and existing object models. Searches are filtered by user-supplied values including searching for objects by relationships. A data and application access service (DAAS) 304 is provided within layer 207 and is adapted to enable applications access to databases and repositories to create data, to read data, to update data, and to delete data (CRUD). DAAS 304 also supports object-locking, viewing object support, object to relational (OR) data mapping, and automated generation of object identifications. SAAS communicates results in an XML-compliant format.

Business logic layer 208 has a unique rating engine 302 provided therein and adapted to compile and serve executable rating models for use in service configuration. A rating model may include many complex sequential calculations performed by the rating engine according to algorithms created for the purpose. Rating data is then compiled and structured automatically including the use of special block translators for resolving scope issues to produce executable rating models that can be stored for execution when needed. It is noted herein that the rating engine has at least one developer interface and tools for generating rating computations. More detail about rating engine 302 including a description of block translators will be provided later in this specification.

Business logic layer 208 also has a KBS configurator 303 provided therein and adapted to generate presentation views containing service configuration results for a specific request. As part of its function, configurator 303 can call a server component of the rating engine to receive rating results that are then configured into a requested service order or request. In one embodiment, the rating engine is further enhanced to provide calculated information other than rating information. Essentially, configurator 303 generates a complete service configuration model that can be presented to a user. The model data produced by the configurator is formatted in an XML-compliant language for platform independence.

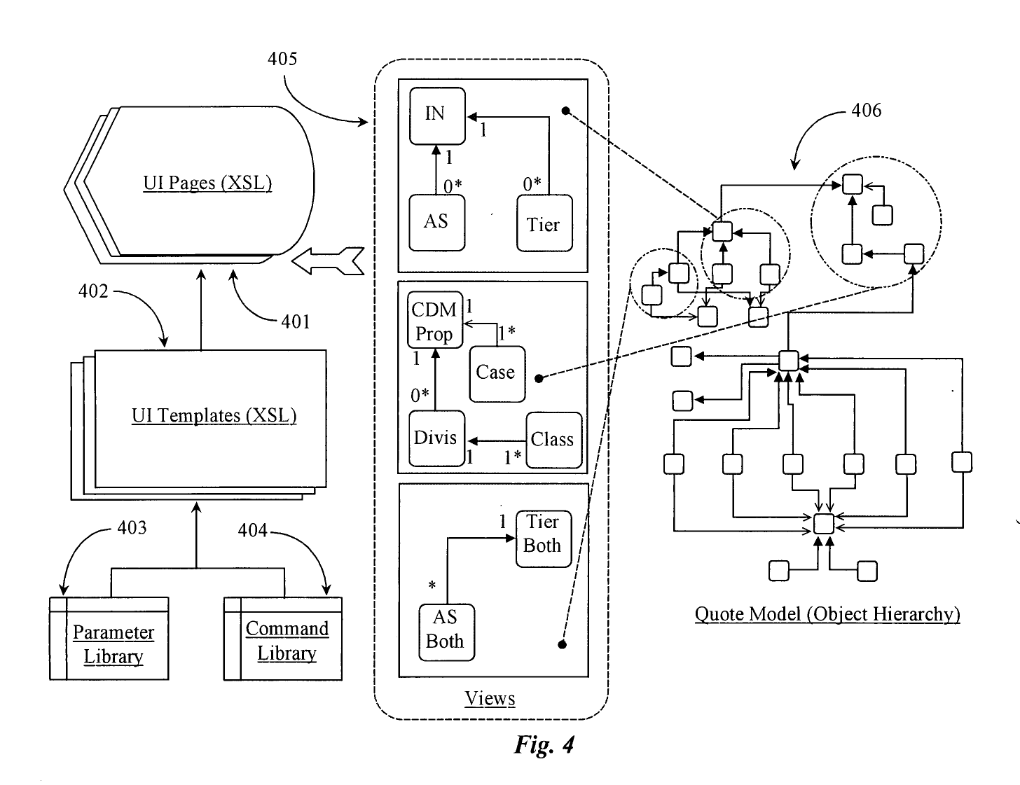

FIG. 4 is a block diagram illustrating UI generation within presentation layer 209 of FIG. 3. UI pages 401 are illustrated in this example and are generated XSL pages that are easily converted to HTML displays using Hyper Text Transfer Protocol (HTTP). UI pages are generated from parameters in a parameter library 403 and from a command library 404, which are accessed to create a UI template 402. UI templates 402 are essentially XSL templates that instruct how a UI is generated and what can be done with it in terms or interaction, how it prints, and so on.

Presentation views illustrated herein as views 405 can be ordered and displayed as UI graphical renditions or graphical user interfaces GUIs. Likewise, a UI for a programmer for example might display a use-case diagram or a selected portion of a united model language (UML) model. Views 405 can include all or a portion of a quote model 406 that is generated according to a user request. In this example, quoting model 406 has selected portions thereof (circled) rendered as views input for generation of 3 separate UI pages, each showing the selected portion of the model.

A view can combine more than one portion of a model including selected attributes and ordered style to generate virtually any kind of XSL interface for reporting rates, reporting parameters, or other information that a user is authorized to receive. It is noted herein that there are many different types of users that may access the system remotely through the presentation layer. Therefore, the types of UI pages served to them including content rendered will vary widely. Typical use is that rating information is displayed for clients that have requested quotes. UI templates are created for planned UI displays and take the appropriate input from generated models.

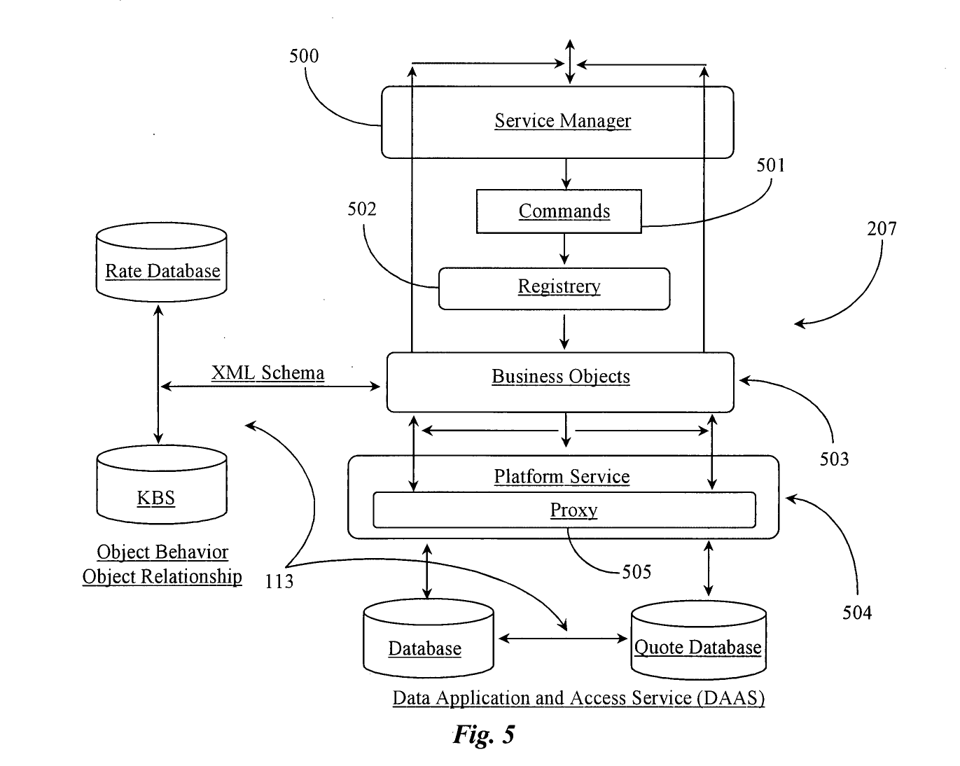

FIG. 5 is a block diagram illustrating the function of DAAS 207 of FIG. 3 according to an embodiment of the present invention. DASS 207 enables automated access to data systems to requesting applications. DAAS 207 uses a service manager illustrated herein as service manager 501 to identify data sources and their locations and to grant access to specific business objects 503 and specified attributes thereof. A registry 502 contains registered business objects that define the data contained in the databases and repositories. Shown here are databases 113 including a quote database, an enterprise database, a rate database, and a KBS. Commands 501 pass into the registry and are applied to or executed on the associated business objects to which the commands apply.

DAAS enables data creation, data reading, data updating, and data deleting. Configuration services and object locking capability are also DASS-enabled functions. Most data accesses by applications are entirely automated and performed in the context of processing an insurance quote or some other task ordered by a user. A platform service 504 having a proxy server component 505 makes the appropriate modifications to the respective data sources identified in the command request. Therefore, manipulations to a business object are translated into the appropriate manipulations to the actual data stored. For example, if a command results in a deletion of a specific attribute of a specific business object the platform service 504 validates the change and by proxy, effects the change in the object data. The next time that that particular business object is invoked, the attribute will not be there.

One advantage of this type of data manipulation is that is affords a measure of security. For example, if a proposed change to a business object causes an unwanted change to one or more other business objects then it can be identified before the actual data is manipulated. Business objects 503 show object behavior as well as object relationships to other objects and attributes. An XML schema is used to describe the objects and attributes and any returned data presented to command author applications for reporting and result display.

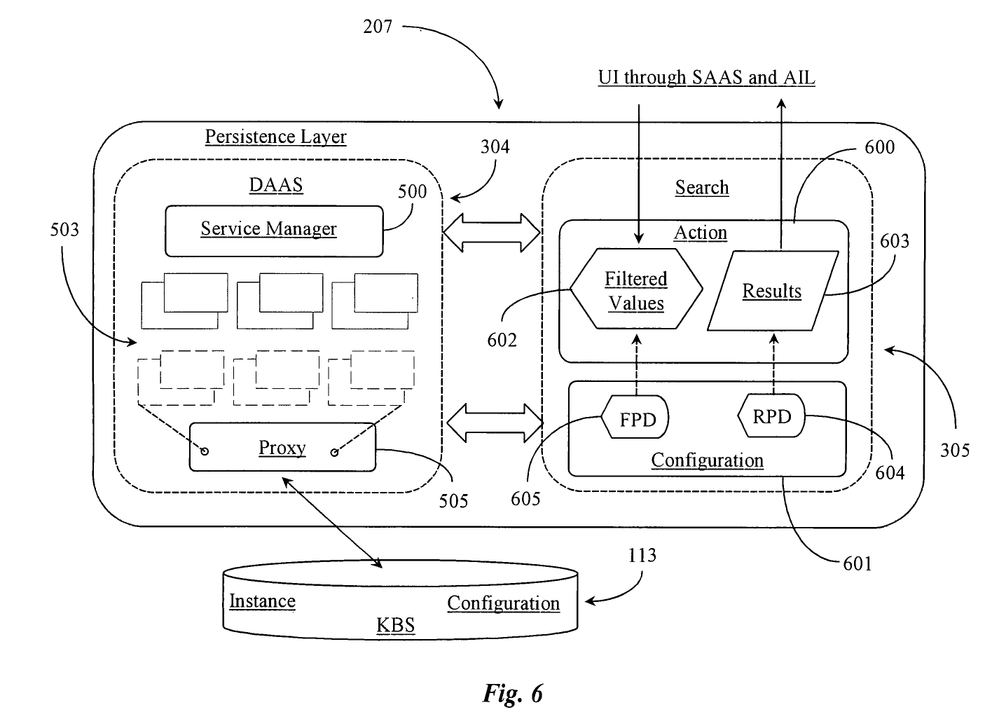

FIG. 6 is a block diagram illustrating internal function of search module 305 of FIG. 3. Persistence layer 207 contains DAAS 304 and search module 305. Search module 305 enables users to perform data searches of repositories 113 based on user input values. Search module 305 has an action container 600 and a configuration container 601.

Search module 600 can be accessed from any user interface after authentication and authorization performed through SAAS. Users, if accessing through an external system may also be routed through AIL described with reference to FIGS. 1 and 2. It is important to note herein that some internal users may have direct UI access to module 600.

Action container 600 is adapted to accept filtered values illustrated herein as filtered values 602 from a user as input for searching. Filtered values 602 may be object relationship values, keyword values, namespace values, etc. Configuration container 601 provides the filter parameter definitions (FPD) 605 for search configuration. For example, an alias for a particular model instance might be submitted for search in all repositories. Container 601 gets associated parameters 605.

Data searching is conducted through service manager 500 and proxy server 505 as was described with reference to data access of FIG. 5 above. Associated business objects 503 are invoked according to input parameters and the desired attributes subject to the search action are identified. Proxy 505 then retrieves those values from the target repository or database and sends the resulting values, sometimes after some ordered calculation is performed, back to container 601. Container 601 then formulates result parameter definitions (RPD) 604 and forwards them to action container 600 as search results 603, which are then sent to the application that invoked the search.

It is noted herein that in object oriented environments, search criteria and optional functionality may include first searching for a particular value or set of values and then performing some operation on the values before returning results. Enterprise data, KBS data, rate data, quote data, and any other connected data source can be searched for any type of data or combination of data sets. Searching can be ordered base on entity relationships, instances of models, instances of configurations, and so on. Client identification, product identification, model alias, keywords, class definitions, etc. can be input as criteria in a data search.

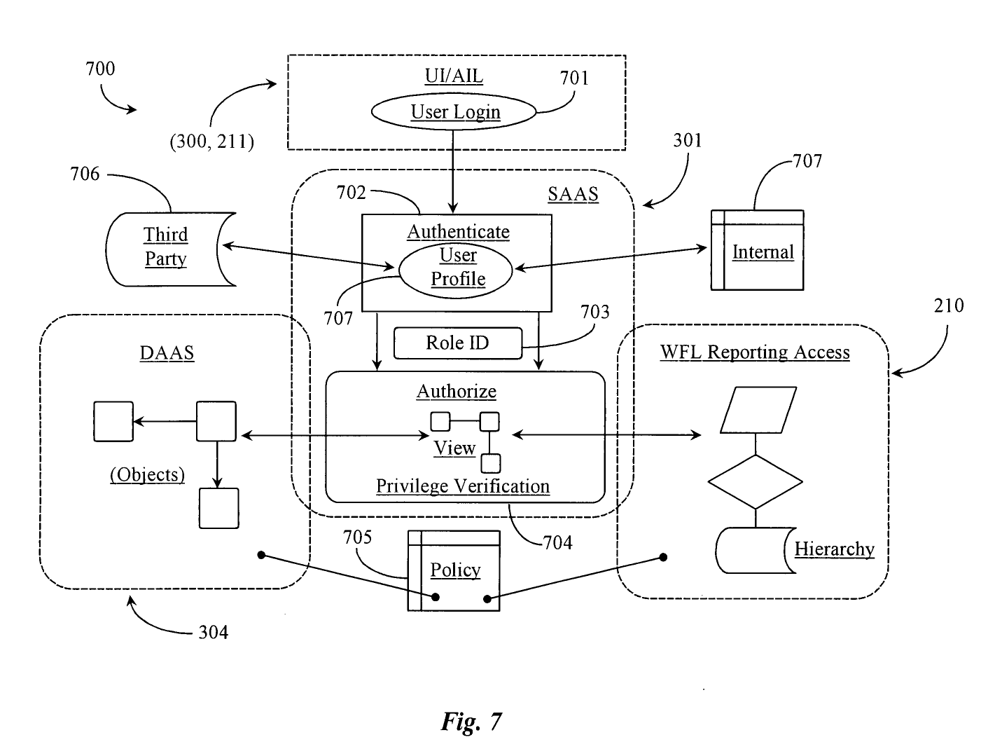

FIG. 7 is a block diagram illustrating an authentication and authorization process 700 enabled by SAAS layer 301 of FIG. 3. At step 701 a user logs into the system through a UI (300) login page and perhaps through the AIL layer (211). SAAS layer 301 first authenticates the user at step 702 according to a user profile 707, which may include a password or other code criteria by way of checking the user information against information stored in an internal repository illustrated herein as repository 707. At the same time, a third party site illustrated herein as site 706 authenticates the user according to the same profile information.

Once a user is authenticated both internally and by a third party, a roll identification illustrated herein as roll ID 703 is assigned to the user. The roll ID determines what privileges the user will receive. For example, a privilege verification step 704 determines by assigned roll ID whether the user will be allowed to view and or manipulate objects through DASS layer 304 and whether the user will receive access to workflow reporting through WFL 210. A policy governing privileges can be accessed from a policy store 705, which would also contain the roll ID code or number assigned. Likewise any level of privilege at any level of granularity may be assigned a roll ID so that if a user is verified to have the assigned ID the user automatically gains the stated privileges for that ID. The users profile is of course also available and known to the system and may already have a roll ID assigned.

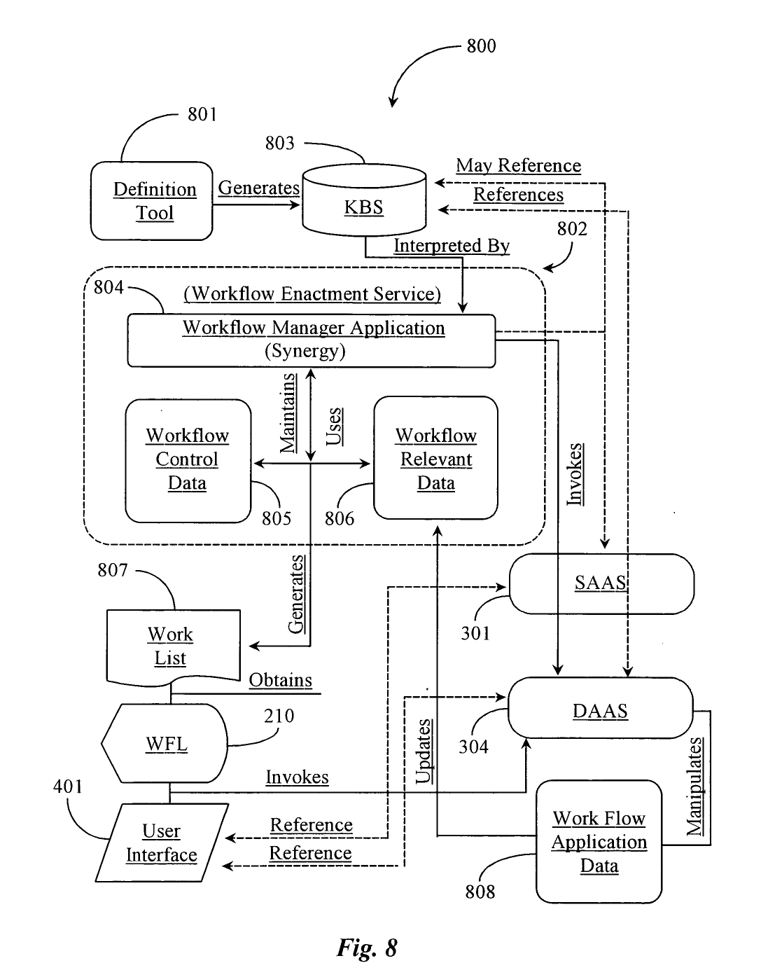

FIG. 8 is an exemplary use diagram 800 illustrating workflow generation and maintenance according to an embodiment of the present invention. During processing of a quote request, an enrollment application, or other service configuration, a definition tool is accessed and used to generate a KBS 803 reflecting an active process or workflow. A generated KBS may reference SAAS 301 and does reference DAAS 304. Knowledge in KBS 803 is interpreted by a workflow enactment service 802, more particularly, by a workflow management application 804 termed “Synergy” by the inventor.

Synergy component 804 generates workflow application data 808 and invokes DAAS 304 to manipulate the data and updates workflow relevant data 806 used by synergy 804 to maintain workflow control data 805. In this way workflow of any project is maintained in a most current state at all times. Enactment service 802 is also accessible directly by an authorized supervisor or administrative controller for the purpose of maintenance and for observation and analysis of efficiency. A user operating user interface 401 may reference DAAS 304 to access data and SAAS 301 for authentication and authorization to view WFL history. Once authenticated, the user may invoke DAAS 304 and interact with synergy 804 to obtain a generated work list 807 by interacting through the workflow layer 210. List 807 may list process steps for a particular service order and the current states of each process in the workflow including any reportable result data tagged to the workflow data. It is noted herein that any application or user-interfacing tool that is to access data must register through DAAS to obtain functional results.

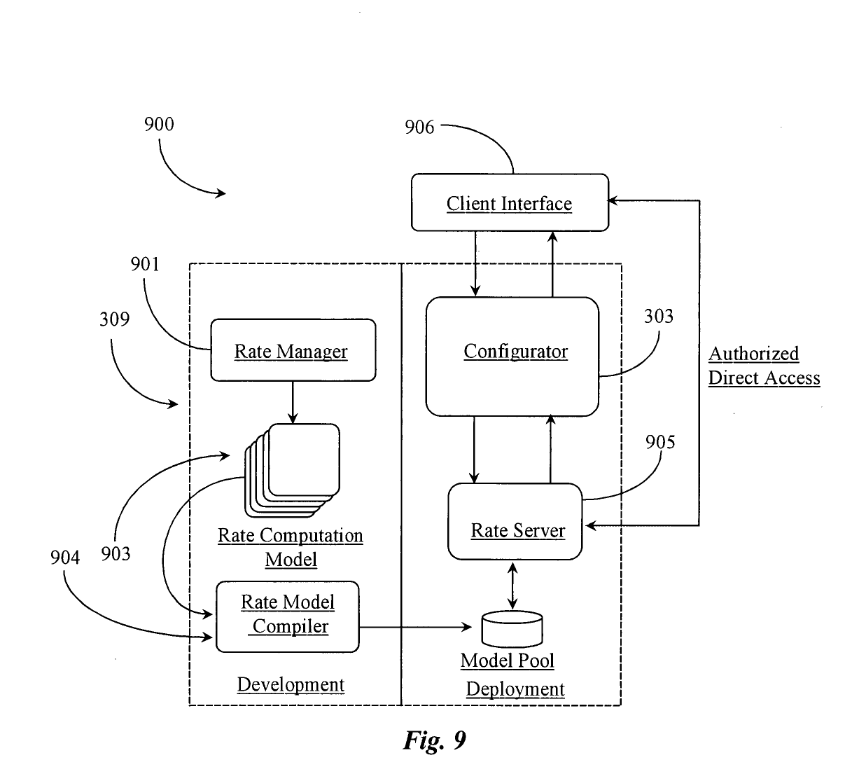

FIG. 9 is a block diagram 900 illustrating internal components of rating engine 302 including its relationship with configurator 303 of FIG. 3. Rating engine 302 comprises 3 main modules, which are a rate manager 901, a rate model compiler 904, and a rate server component 905. Rate manager 901 is a graphical user interface (GUI) in the form of a spreadsheet application rich in functions and workspace. Rate Manager 901 allows a user to model computation logic used for creating an executable rate model. Logic is created using cells and insertable functions very much similar to standard spreadsheet functionality. After logic is created and validated in rate manager 901, the logic is saved into an XML file termed a rate model or rate computation model (903). Rate manager 901 is adapted to utilize any JDBC compliant database using an application program interface (API) that enables interpretation of XML data and output of XML data.

Rate computation models 903 contain all of the calculative formulas and algorithms, input parameters (constants, variables), and output parameters (data, number, format) for performing complex rating. Rate model compiler 904 is a batch program that takes rate computation model 903 saved in XML format, as input and performs a sophisticated dependency analysis. At the end of the dependency analysis, compiler 904 outputs an executable component. The executable contains the computation that was modeled by the user operating rate manager 901.

Executable components output from compiler 904 are stored in a rate model pool and are accessible through an illustrated rate server 905. Rate server 905 is an enterprise-class, multithreaded, and multi-user access server, that is specifically adapted for an Internet or Intranet platform. Rate server 905 exposes executable rate models as a service that can be accessed concurrently by multiple users or applications of the enterprise. Rate server 905 is also accessible through web clients like Internet browsers and other navigation-capable devices. In preferred embodiments, server 905 is also accessible directly from interface 906 for authorized access situations. In one embodiment, Rate server 905 can be used in a mobile wireless access embodiment. Documents served from rate server 905 are, in a preferred embodiment of the form of XML over HTTP on TCP/IP.

In this example, KBS configurator 303 is accessing rate server 905 in order to obtain an executable rate model for the purpose of supplying rating information to a user operating through a client interface 906. Configurator 303 is adapted to perform certain calculations and product related service configurations to produce a complete KBS model describing a service package that can be used, for example, for insurance enrollment according to a specific insurance plan. Configurator 303 executes a model obtained from server 905 into its KBS model and then can return rating results to a requesting application or user. The relationship between the configurator and the rating engine is a request response relationship initiated from the configurator. Other than this relationship they are independent systems. Moreover, the rating system can be used independently from configurator 303 without departing from the spirit and scope of the present invention.

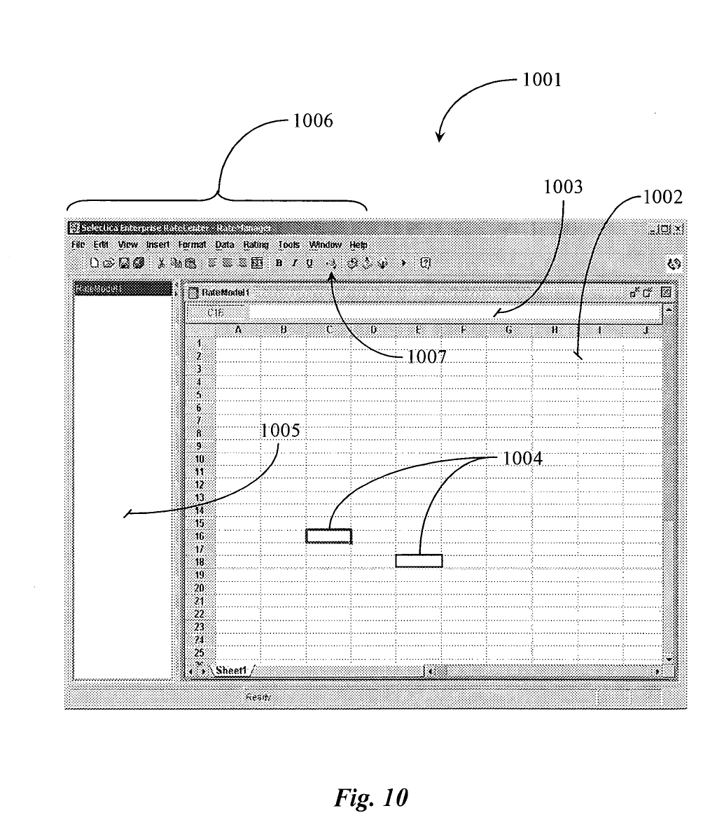

FIG. 10 is a screen shot 1001 of rate manager application 901 of FIG. 9 according to a preferred embodiment of the present invention. Screen 1001 represents an open GUI ready for use. Screen 1001 has all of the familiar drop down menu options 1006 that are normally seen in a standard spreadsheet application interface like file, edit, view, format, data, tools, window, and help. An added drop-down menu is illustrated herein and labeled “rating”.

Screen 1001 has a workspace window 1002 containing rows labeled numerically, columns labeled with letters A-Z, and data cells 1004. This configuration is essentially identical to known interfaces like MS-Excel™ for user convenience. A formula bar 1003 is provided and adapted to display any formulas attributed to any cells 1004. A side bar window 1005 is provided to list models already created and for navigating to other functions which when selected bring up other workspace windows or sub-interfaces. A database connectivity icon 1007 is provided for specifying a database to connect to for importing data for creating models and for importing model data from models already created.

Referring back to FIG. 9, rate manager 901 also has a testing environment termed a Rate Test Environment (RTE) not illustrated but assumed to be present. The testing environment is used to validate rate models by test executing them. More about testing rate models will be described later in this specification.

Referring back to FIG. 10, a user creates business computations including calculations, using rate manager tool, as they would normally do in a spreadsheet interface like Microsoft Excel™ or some other standard spreadsheet application. After entering a computation, the user then indicates or marks specific cells 1004 in workspace 1002 that will carry the input to the computation and cells 1004 that will display results of the computation. Designation of input and output cells is required for successful execution of a rate model in a production environment.

There are a number of additional functionalities that rate manager 901 (FIG. 9) provides over typical spreadsheet applications. Some of the more important functions not available from existing spreadsheet applications include:

Enhanced lookup capabilities with respect to databases including; Dynamic Queries; Static Queries; Cached Queries; Parameterized Queries; and Dynamic Defined Names.

Capability for Performing Looping operations in calculation including; Loop Add; Loop Multiply; Loop And; Loop Or; and Loop Append.

XML input/output including;

GetValue; SetValue; and IsNull.

Capability for outputting results in XML format; Capability for designating a rate model as a user-defined function to be used in another rate model; Capability for distributing user-defined functions in an accessible user library or archive; and Capability for importing computations created in MS Excel™.

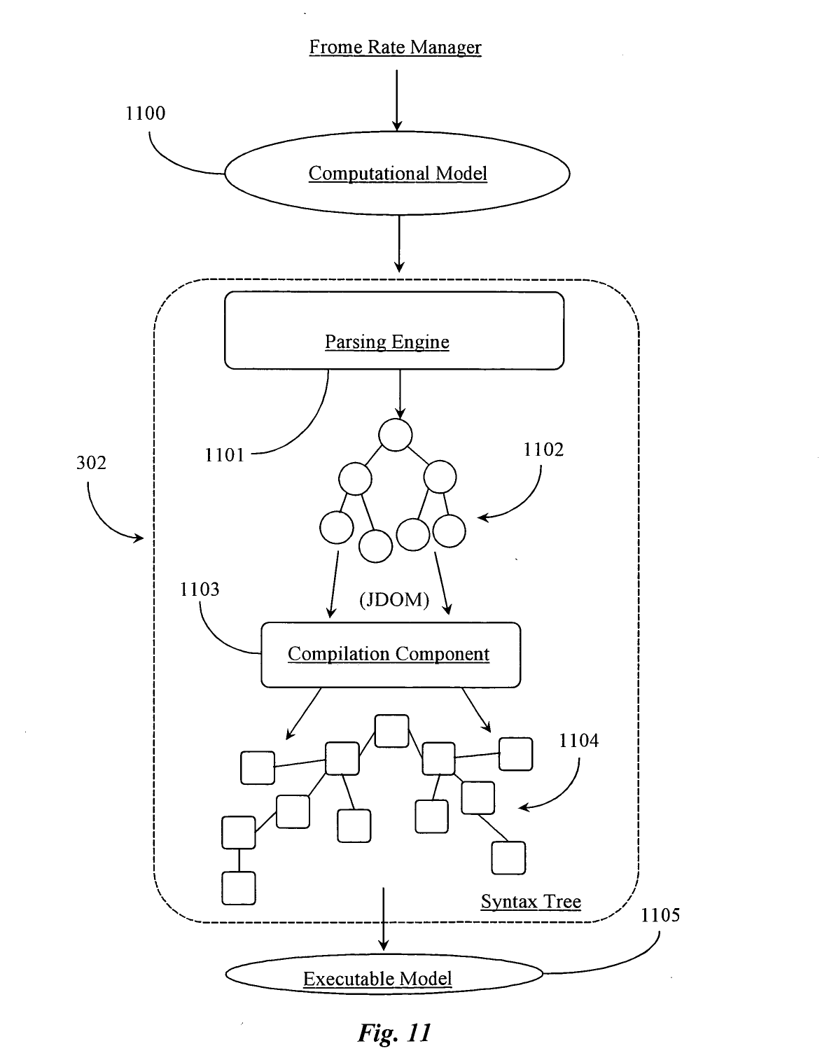

FIG. 11 is a block diagram illustrating a function of creating an executable model 1105 from a computational model 1100 using rate compiler 904 of FIG. 9 according to a preferred embodiment of the present invention. A computation model 1100 is analogous to models 903 described with reference to FIG. 9 above. Model 1100 is output from a rate manager GUI interface analogous to screen 1001 as previously described.

A parsing engine 1101 is provided as part of the rate compiler and accepts computation model 1100 as input. Parsing engine 1101 is in a preferred embodiment capable of parsing XML and outputting or rewriting the file as a Java Document Object Model (JDOM), which is an API for representing XML in a more JAVA friendly manner.

A compilation component 1103 is illustrated herein and includes a lexical analyzer, sometimes referred to in the art as a scanner. Compilation component 1103 builds a sophisticated dependency tree or syntax tree represented herein as syntax tree 1104 from the JDOM file structure. The compiler outputs an executable component illustrated herein as executable model 1105. Model 1105 is simply executable Java bytecode for the created computation model created using the rate management tool.

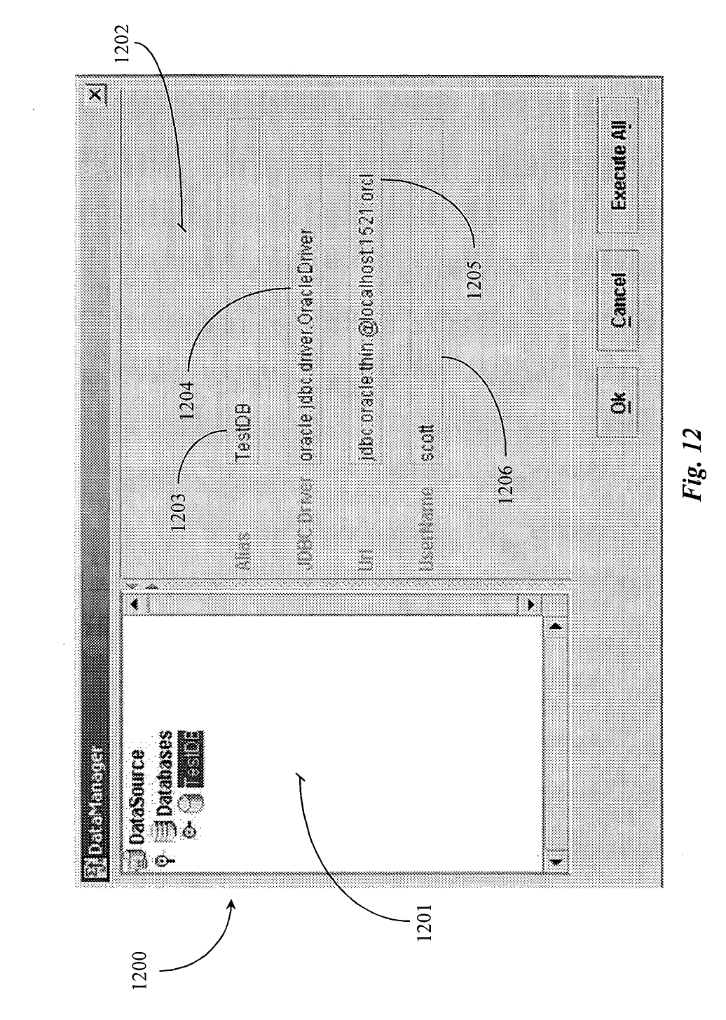

FIG. 12 is a screen shot of a data manager interface 1200 of rate manager interface 1000 of FIG. 10. Data manager interface 1200 has a navigation bar window 1201 adapted to list data sources and databases in a hierarchical fashion for navigating to desired data sources. In this example, the desired data source is a test database labeled “TestDB” in window 1201, which is categorized under “Databases”, which is categorized under “DataSource”. A window 1202 appears upon invocation of the selectable icon TestDB.

Window 1202 has an input field “Alias” for naming the database. An input field 1204 is provided for specifying the driver of the database, which in this example is oracle, jdbc.diver.OracleDriver. An input field 1205 is provided for specifying the location of the database. An input field 1206 is provided for specifying the name of the user accessing the database.

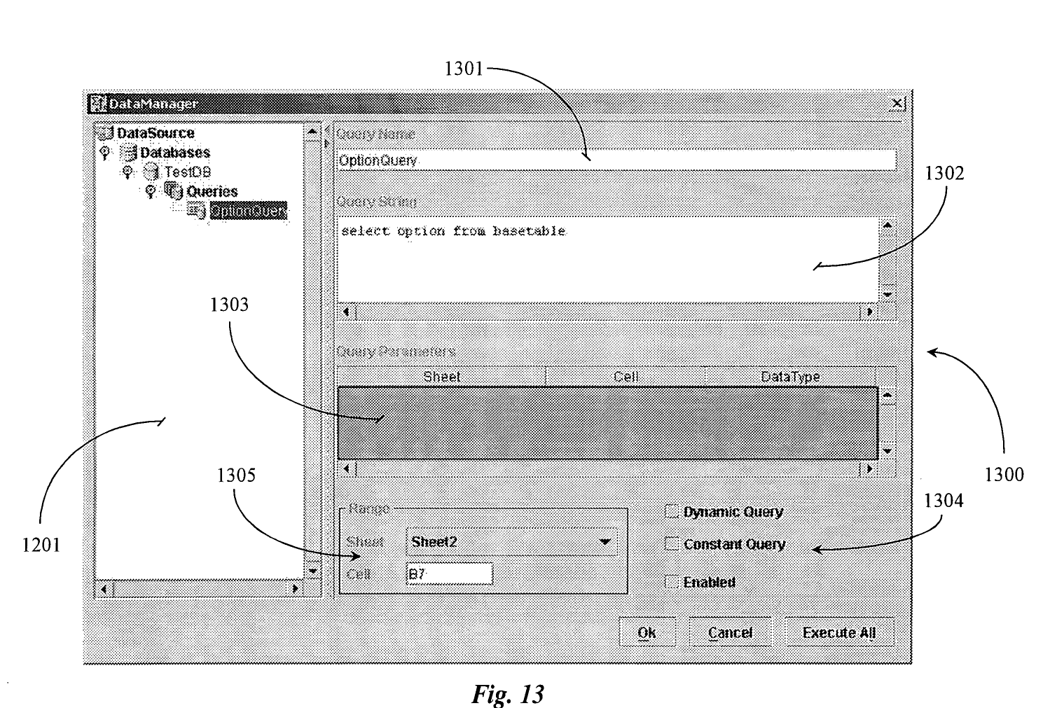

FIG. 13 is a screen shot of a subsequent interface 1300 of data manager interface 1200 of FIG. 12 illustrating a query submission interface. Navigation bar 1201 is still visible wherein the user has navigated down to “Option Query” and selected the icon to call up a window containing fields for specifying a query. For example, a query name field 1301 is provided for name specification. An input field 1302 is provided for inputting a query string. An input field 1303 is provided for inputting query parameters.

A range specification box 1305 is provided for specifying a worksheet and cell. A query selection option block 1304 is provided for specifying whether the query is a dynamic or a constant query. This block can be enabled or disabled.

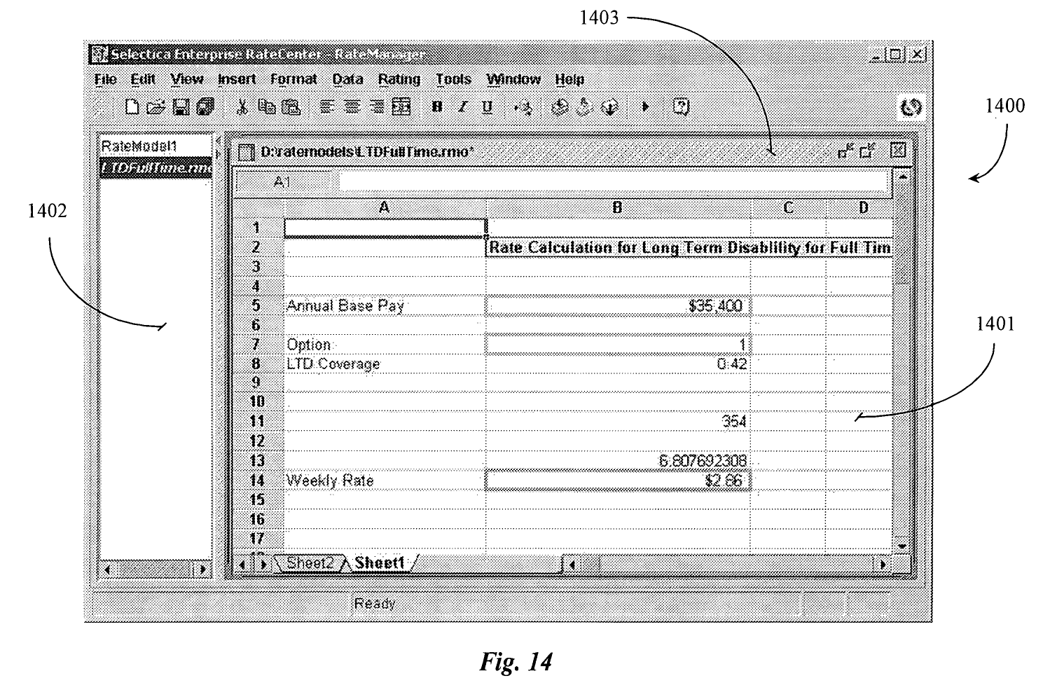

FIG. 14 is a screen shot of a rate manager result interface 1400 returned from the query submission of FIG. 13. Interface 1400 has a workspace window 1401, a navigation bar window 1402 and a title bar 1403. Navigation bar window 1402 indicates that the workspace 1401 shows the long-term disability (LTD) rate calculation for a fill time employee. In window 1401, cell B5 shows an annual base pay of $35,400. According to option 1 (B7) selected for review in the query submission described with reference to FIG. 13, LTD coverage value is 0.42 (B8).

Cell B11 illustrates a calculated result value 354 and cell B12 illustrates a factor of 6.807692308. The calculated weekly rate is $2.86 as identified in cell B14. All calculated rate models are reviewable through interface 1400.

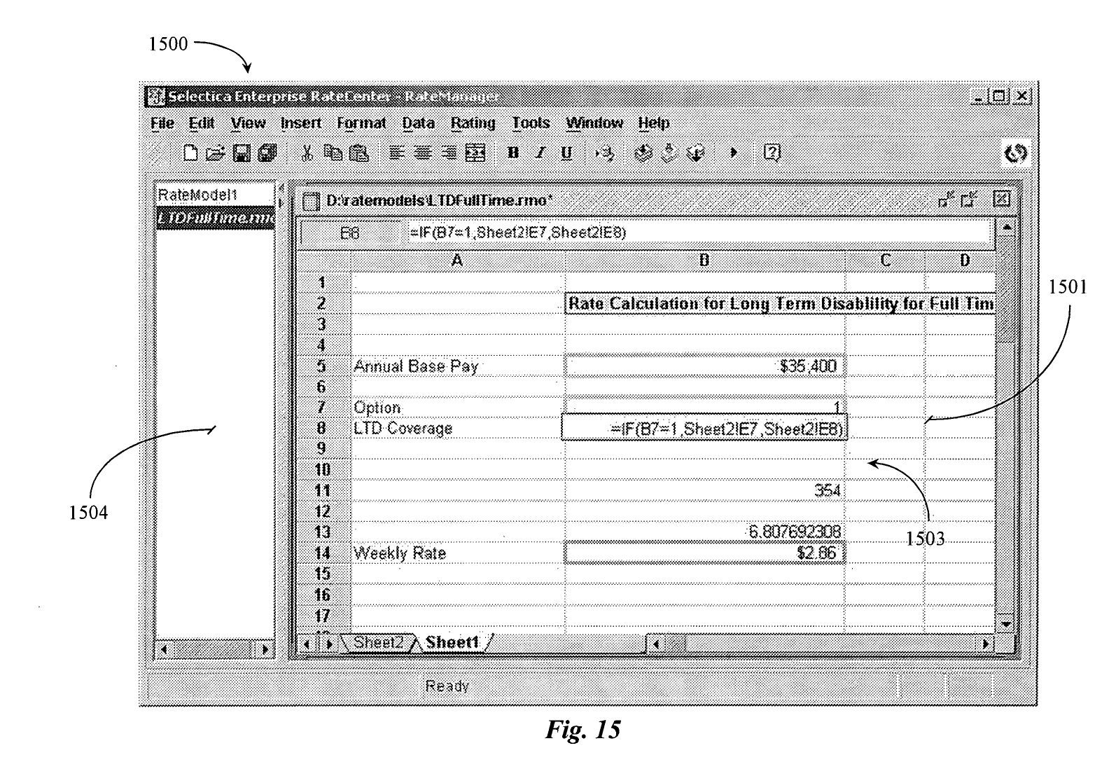

FIG. 15 is a screen shot of an interface 1500 revealing a first algorithm inserted as a function in cell B8. Window 1501 and 1504 are analogous to windows of the same description described with reference to FIG. 14. The displayed data, cells B5, B7, B11, B13, and B14 show the same data as the cells of FIG. 14 accept that in cell B8, the inserted algorithm is displayed instead of the result value 0.42. The algorithm is created using the “Insert” followed by “Function” as is practiced in other spreadsheet type applications. The algorithm is displayed as follows:

=IF (B7=1, Sheet2!E7, Sheet2!E8).

It is noted herein that LTD rates as well as short-term disability (STD) rates and rates associated with other insurance product plans like dental, medical or life insurance may be calculated. Moreover, rating may be calculated for other types of businesses. There are many possibilities.

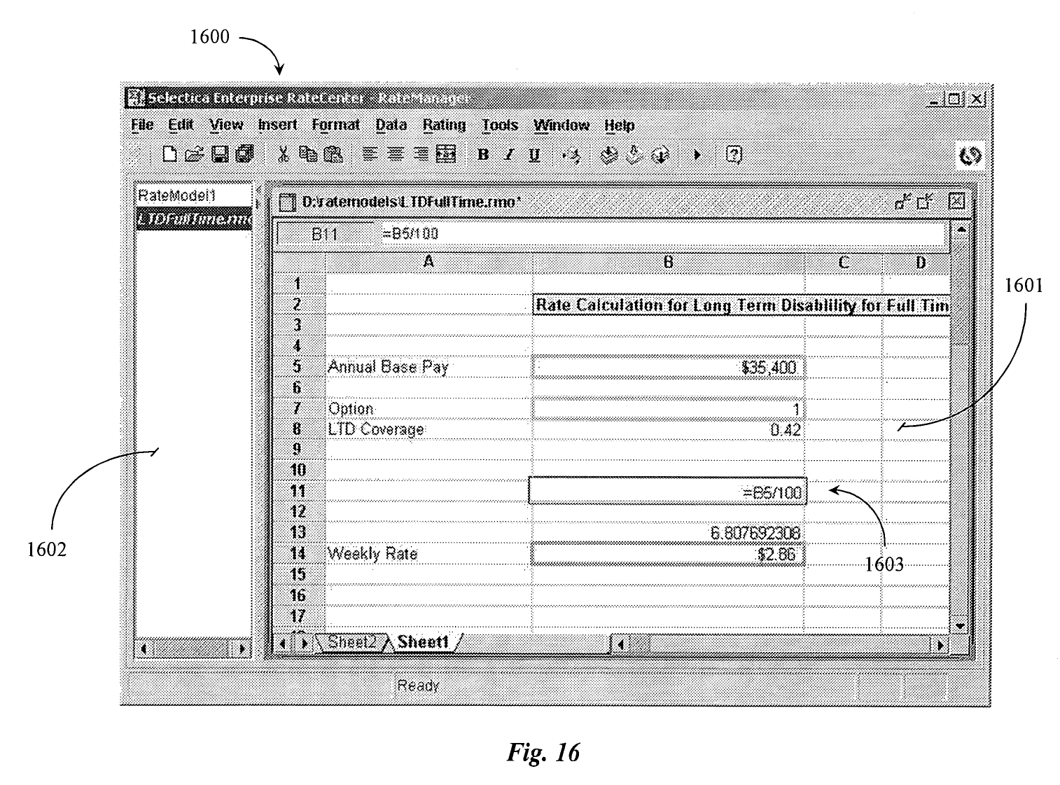

FIG. 16 is a screen shot of a rate manager interface 1600 illustrating a second algorithm being inserted into cell B11. Elements 1601, 1602, and 1603 are analogous to their counterparts of FIGS. 14 and 15. The cell data in this screen shot is identical to that of window 1401 of FIG. 14 except that a second rate algorithm=B5/100 is displayed in place of the result value 354.

Using a standard spreadsheet “function” or “formula” insert tool makes writing the rating algorithms a very user-friendly experience. The rate manager interface is a procedural computation engine that works with any JDBC compliant database. All rate models are executable through the interface and “what if” scenarios can be explored in an interactive fashion. All output from the rate manager is in the form of XML.

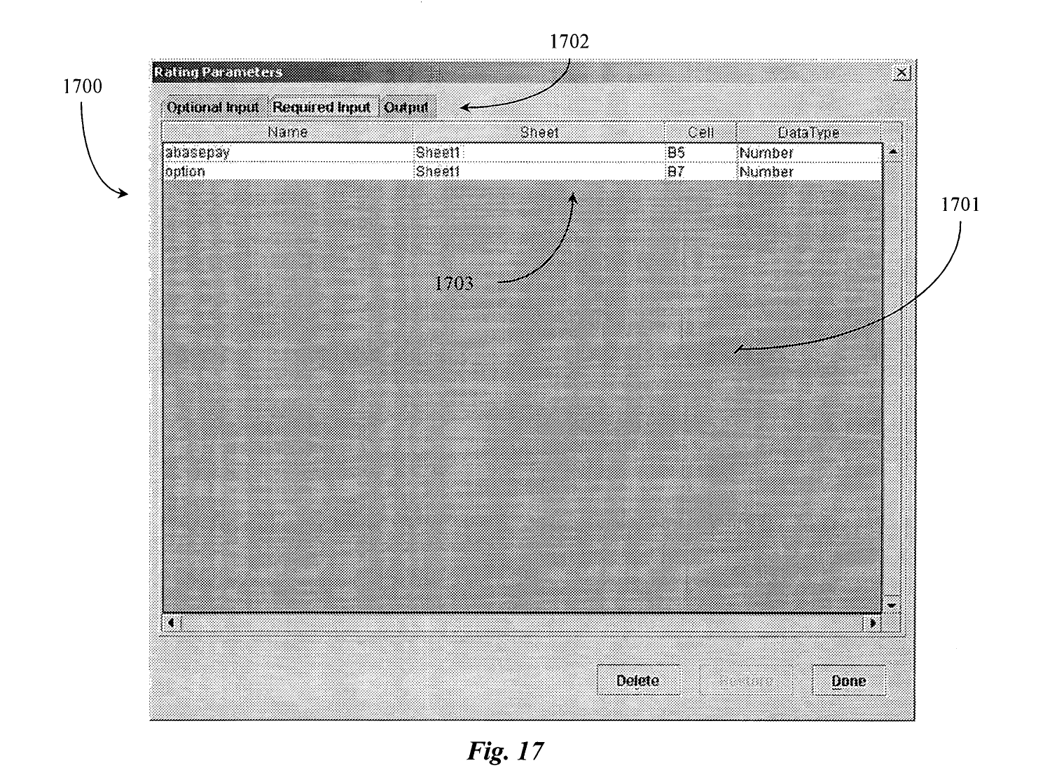

FIG. 17 is a screen shot of a rating parameters interface 1700 of the rate manager interface 1001 of FIG. 10. Interface 1700 has an option 1702 for selecting which type of parameters are input at any given time. It is noted herein that there will be required input parameters and required output parameters and “optional” input parameters. The required parameters must be entered in order for successful execution of the associated rate model in a production environment.

A workspace 1701 is provided to enter the parameters. Listed parameters 1703 include a parameter name, specification of the specific spreadsheet the parameter will reside on, a cell specification for the parameter, and a data type for the parameter. Two parameters are listed in workspace 1701 the first being abase pay on sheet 1 cell number B5, data type=number ($35,400 from FIG. 14). The second parameter is named option, entered on sheet 1, cell number B7, data type-number (1 from FIG. 14). At the bottom of the display there are buttons for delete parameters, restore parameters, and “Done”.

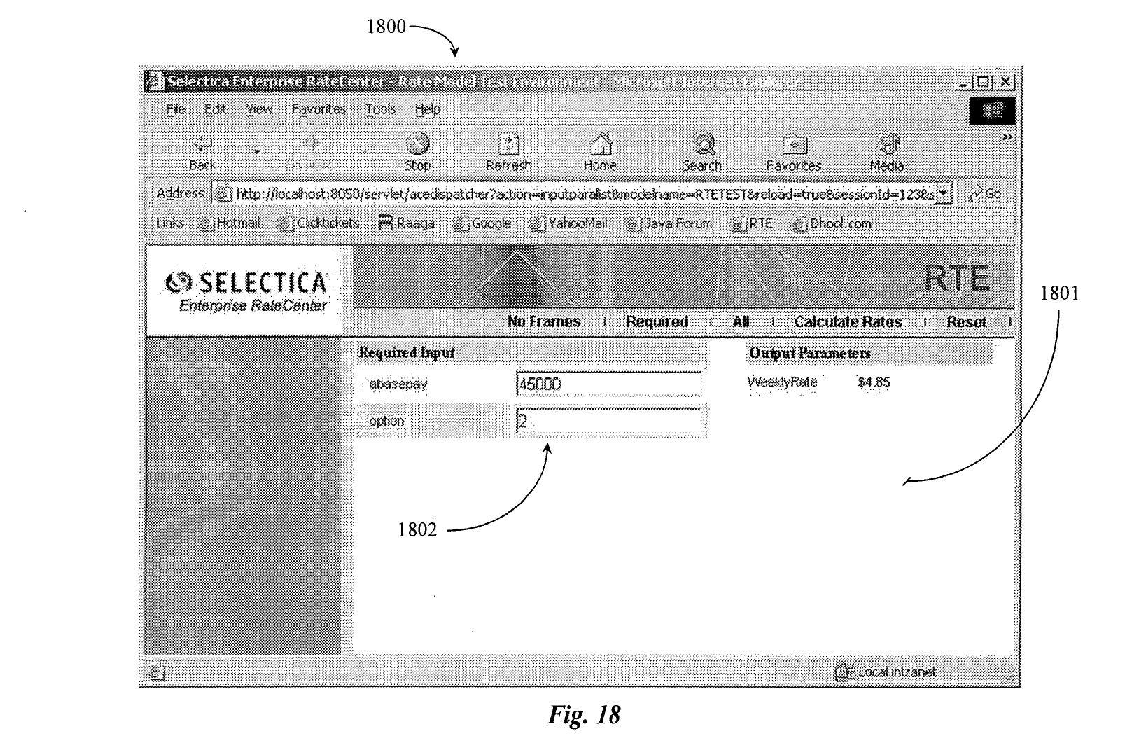

FIG. 18 is a screen shot of a rate model-testing interface 1800. Interface 1800 enables model execution and testing. As previously described above, the rate manager includes a rate-testing environment (RTE).

A workspace 1801 is provided with entry fields 1802 for entering the required parameters for testing the associated rate model. In this example a base pay parameter of 45,000 is entered followed by an option scenario 2. The output parameter displays the weekly rate of $4.85.

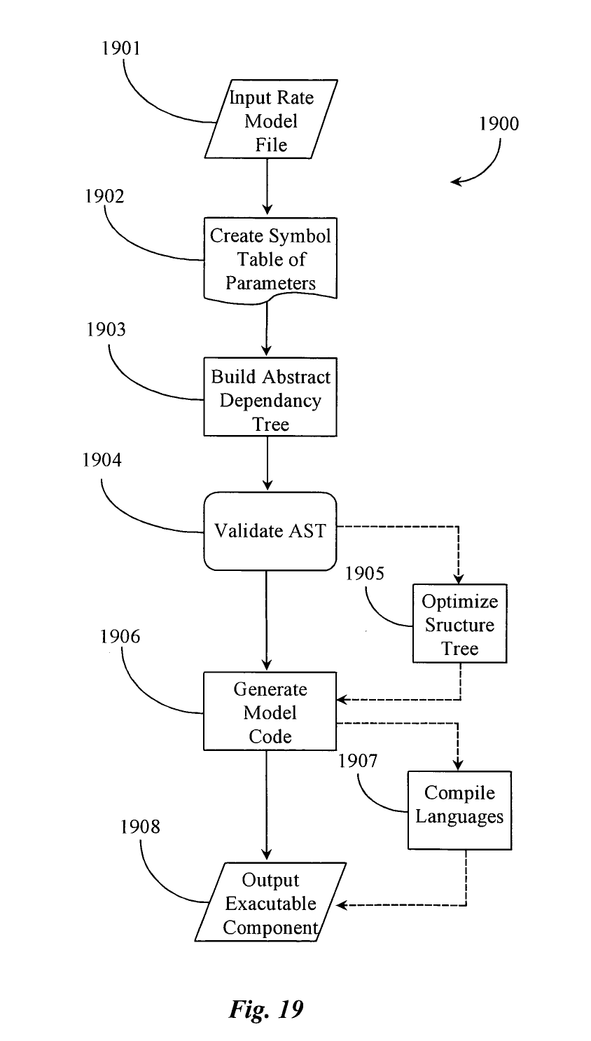

FIG. 19 is a process flow diagram 1900 illustrating steps for compiling a JDOM executable component from an XML rate computation model according to an embodiment of the present invention. At step 1901, a rate model file is input into the compiler process. The rate model file is output from the rate manager. At step 1902, a symbol table of parameters is generated to keep track of the parameters used to build a hierarchical structure tree from the file. This step occurs as the rate data is being parsed. Some of the parameters tabled include:

1. Cell Reference

2. Defined names

3. Value format string for cell

4. Formula associated with cell

5. Value associated with cell

6. Data type of a cell

7. Rate Parameter information

At step 1903, an abstract dependency tree (AST) is created from the parsed XML file via a lexical scanner application. It is noted herein that the output of the XML parsing application of step 1902 is a JDOM structured file. One with skill in the art of XML programming will recognize that in any program, there needs to be a starting point where the compiler should start its scanning process and an end point where the process should terminate. With respect to the rate manager, this information is captured via the rating parameters. For example, any cell in the Rate Manager Interface (except an error cell) can be marked as a rating parameter. The rating parameter is associated with a name that identifies the value of the rating parameter.

At step 1904, the rate model node hierarchy is validated. Optionally, at step 1905 the rate compiler AST tree is optimized. At step 1906, model code is generated for describing the model according to a given markup language. The code generator is a plug-in software component that in a preferred embodiment operates according to a default JAVA language library. However, the code generator of step 1906 can be programmed to code in C, C++, PL/SQL, or any other modeling and/or programming language.

Another optional step 1907 includes a language compilation procedure to optimize the description of the model structure and attributes. At step 1908, an executable component is output and can be stored in the enterprise rate server's model pool.

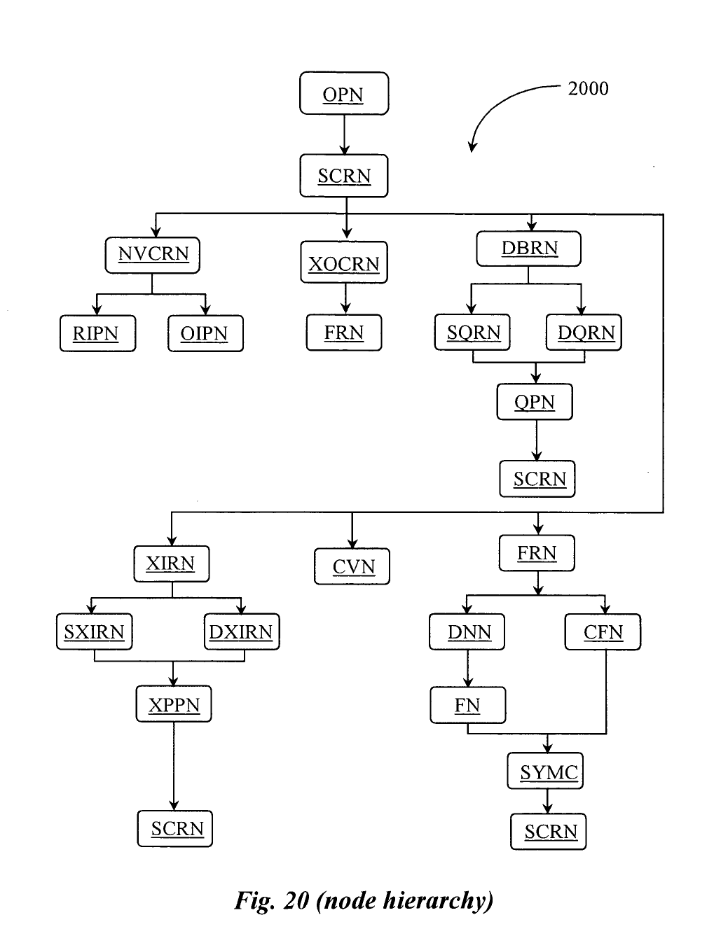

FIG. 20 is a block diagram 2000 illustrating an exemplary Abstract Structure Tree (AST) node hierarchy 2000 produced through compiling and lexical analysis. Diagram 2000 shows the node hierarchy, their inter-dependencies and their flow. In general, a cell in spreadsheet can contain a formula or a constant or data that is pulled from database or XML input. Result cells are marked as output parameter cells.

For each type of cell, a rate compiler will create the corresponding tree nodes during the compilation process. A rate compiler analogous to compiler 904 described with reference to FIG. 9 above starts with an output parameter node labeled herein (OPN) and starts tracing the dependencies with other cells. Each of the cells that participate in arriving at an output (marked by a user as an output parameter) can be one of the following;

Formula

Constant

Data from DBMS

Data for XML

Data via arguments passed at invocation time (applicable for rate functions)

At the root of the tree is (OPN). Next in the tree and directly dependant to OPN is spreadsheet cell reference node (SCRN). In case of formula cells, the formula is parsed and its relationship is analyzed with other cells in the spreadsheet and a tree is built. This specialized task is performed by a sub-system in the compiler called the “symbolic compiler”. A spreadsheet is a loosely typed system. Therefore there is a need for converting computation from a spreadsheet definition to a strongly typed language definition. The symbolic compiler described above also performs this process. The Symbolic compiler does this intelligently and efficiently without the need to execute the formula to determine the resultant data-type.

It is noted herein that the dependency tree continues down from SCRN to include an XML output cell reference node (XOCRN) and a formula reference node (FRN). Also depended from SCRN is a name/value pair cell reference node (NVCRN). An NVCRN can be a required input parameter node (RIPN) or an optional input parameter node (OIPN).

A database reference node (DBRN) depends from SCRN in this tree and can fetch data according to two types of queries, static queries and dynamic queries. Hence the nodes illustrated herein as a static query reference node (SQRN) and a dynamic query reference node (DQRN). In case of static queries, the number of rows and columns that are returned by the execution of the queries are always constant. Using the compiler optimizes the generated code for higher system performance.

In case of dynamic queries, the number of rows returned by the query, is not constant. This may vary due to a number of reasons, including the query parameters. Due to the fact that dynamic queries return varied number of rows (tuples), the compiler creates a looping construct to iterate through the rows. Prior-art computational systems do not handle dynamic queries in this way. Cells under dynamic queries are treated as loop cells and associated reference cells are also considered as loop cells unless the system employs a loop termination formula like, LOOPADD, LOOPMULTIPLY, LOOPAPPEND, LOOPAND, or LOOPOR.

The following pseudo code illustrates the above-described process.

For every record in a Query Result, Do

Calculation 1
Calculation 2
. . .
Calculation n
   End For

The dynamic query cell identifies the beginning point of the loop and the cell that uses the loop formula identifies the end of the loop. The system of the present invention also supports “nested” and multiple queries in parallel. The compiler would perform nested and parallel loops during the compilation process according to query type. This capability is also a unique capability of the rating system and is novel above systems of prior art

Following is an example of a nested query loop:

Nested Query example:

If a dynamic query, say Query2 for example, takes loop cell or cells of another dynamic query say Query1 as its query parameter (QPN), then Query2 is considered a nested query of Query1.

For every record in Query1 result

Do

X=Calculation 1
:
Calculation n
   For every record in Query2 result where X is a query parameter
   Do
Calculation 1
. . .
Calculation n
   End For
   End For

Following is an example of a parallel scenario:

Parallel Query example:

If there are a plurality of dynamic queries that do not have any query parameter relationships as mentioned above, but loop cells from such dynamic queries are used to construct a formula, then those dynamic queries are considered a parallel queries. The pseudo code for such cases would be,

For every record in Query1 Result, Query2 Result, . . . Query n Result, Do

Calculation 1
Calculation 2
. . .
Calculation n
   End For

In case of XML input, it is analogous to database input except that Xpath queries are used instead of SQL queries and the retrieval of values from input XML is performed using a special formula “GetValue” instead of dialog based approach as in database. This also has the concept of static and dynamic inputs as explained above. All the above-mentioned loop-terminating formulae are valid here also.

Referring back to FIG. 20, further down the tree an XML input reference node (XIRN), a constant value node (CVN), and a (FRN) are illustrated. An XIRN may be a static XML input reference node (SXIRN) or a dynamic XML input reference node (DXIRN). Depended there from are an illustrated Xpath parameter node (XPPN) resolving to (SCRN).

Under FRN there is illustrated a de-field name node (DNN) resolving to a FN and a custom function node (CVN). A symbolic compiler (SYMC) under FN resolves to an SCRN.

In addition to generating looping constructs as exemplified above, the system compiler also resolves issues of scope for variables included in any loop functions.

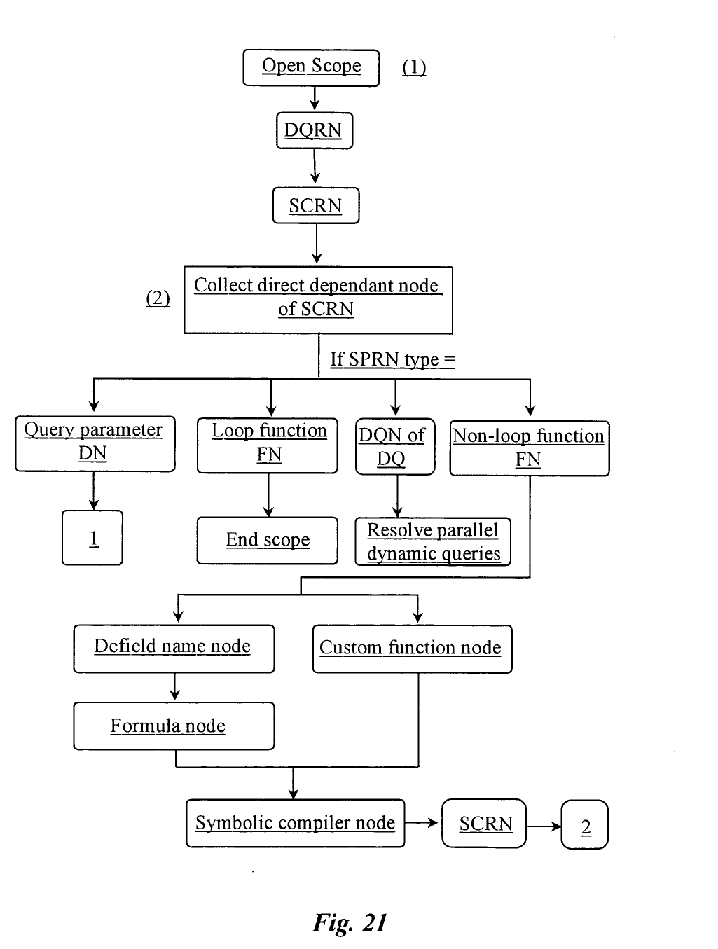

FIG. 21 is a block diagram illustrating resolution of variable scope issues. In this example of scope resolution a dynamic query result node referenced herein as (DQRN) is assumed to include both database queries and XML dynamic queries. When encountering a dynamic query result cell, the compiler opens a new scope for the variables that participate in the loop. Also cells that are depended from (SCRN) above are identified.

Referring now to FIG. 21, the compiler opens scope (1). A dynamic query result node (DQRN) has a spreadsheet cell reference node (SCRN). The compiler collects nodes that are depended from SCRN (2). The dependent nodes could be any one of the following illustrated herein.

Query parameter of dynamic node (Query parameter DN)

Loop function formula node (Loop function FN)

Dynamic query node of a dynamic query (DQN of DQ) or

Non-loop function formula node (Non-loop function FN).

If the node is a query parameter of a dynamic node then nested loops are generated in the rate model code. If the node is a loop function formula node then it is marked as the end of the loop and the generated code will reflect the same in terms of scope and loop construct.

If the node is a cell that uses a computation from the current dynamic query and also of another dynamic query and the two queries do not have a parameter-based relationship, they are considered parallel queries and variable scoping is performed accordingly.

If the node is a non-loop function formula (traditional spreadsheet formula) then calculation statements are created inside the loop using a local scope.

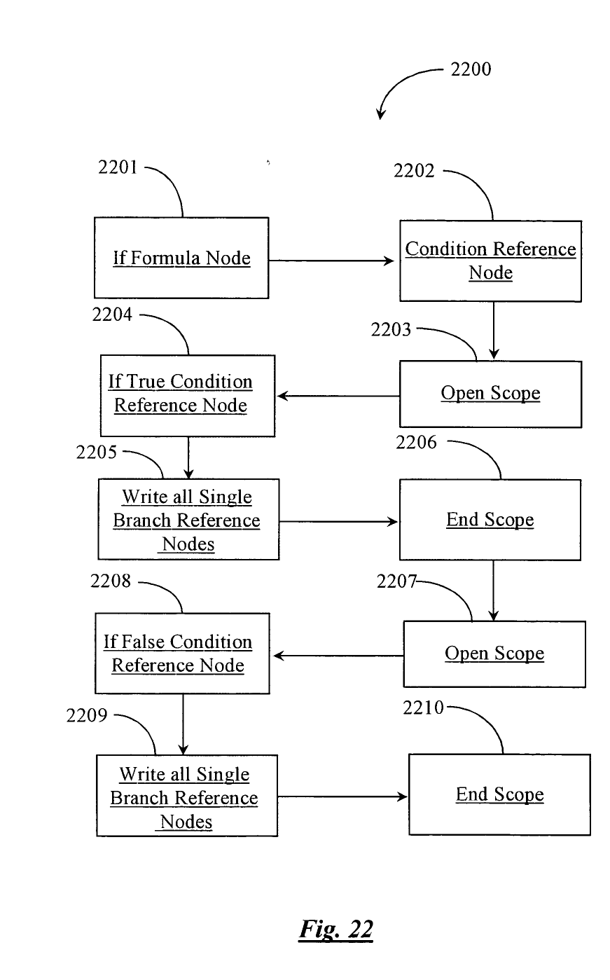

FIG. 22 is a process flow diagram 2200 illustrating a block translation example according to an embodiment of the present invention.

In a spreadsheet “if” is treated as a formula and the correct syntax is as follows; If(<condition>, <true statement>, <false statement>).

The compiler translates the above formula into a high-level syntax as follows:

If(<condition>)
{

<true statement>

}
else
{

<false statement>

}

In cases where the statement in the “true”/“false” section are dependent on other cells, they form a single branch hierarchy. The cells participating in this hierarchy are primarily contributing to the “true” or “false” result and they have no other dependencies. The compiler detects this and they are intelligently included in the “True” or “False” section of the “IF” block as appropriate. This will result in increased performance and more robust rate model.

If<Condition>
{

<All single branch references for true statement >
<True Statement>

}
Else
{

<All single branch references for false statement >
<False Statement>

}

Therefore at step 2201, if the reference node is a formula node, in step 2202 the node is conditioned. At step 2203 the scope function is opened. If the node condition is true in step 2204 then at step 2205 all linear reference nodes for that condition are written. At step 2206 the scope function ends. At step 2207 the scope function opens. Ay step 2208 if the condition of the node is false then at step 2209 all linear references for that condition are written. At step 2210 the scope function ends.

It will be apparent to one with skill in the art of object oriented programming that the dynamic rating engine of the present invention enables instant rate calculation according to an instant service configuration that can call and receive such rating results using remote method invocation (RMI), remote call procedure (RCP) or other suitable network protocols that may be implemented in conjunction with the use of accessing Web services without departing from the spirit and scope of the present invention. Configurations accessed by clients or brokers of clients can be Web-based and accessed via various client devices having network-capable Web-browsers, Lite browsers, or mini browsers installed on mobile devices.

The system of the invention can be distributed to many network connected servers for the purpose of scaling up or down as desired. Likewise, main operational layers of the foundation services, of which the rating engine is a core component, may be distributed to more than one server or maintained in one host machine.

The method and apparatus of the present invention should be afforded the broadest possible scope under examination in light of the many flexible embodiments, some of which have been described. The spirit and scope of the present invention should be limited only by the claims that follow.

What is claimed is:

1. A procedural computation engine for generating and serving executable high-level code comprising:
a Graphical User Interface for creating procedural computation schemas;
a parser for interpreting output from the Graphical User Interface;
a compilation component for hierarchal node-structuring of data; and
a server component for providing access to generated information;
characterized in that a programmer operating through the Graphical User Interface pre-creates at least one procedural computation schema including the algorithmic function or functions and input needed to produce computational results, the data of the schema output as a markup file interpreted by the parser and in cooperation with the compilation component generates an executable computation model accessible and executable through the server component.

2. The computation engine of claim 1 wherein the Graphical User Interface is of the form of an interactive spreadsheet processing application and the computation model is a rating model.

3. The computation engine of claim 1 wherein the parser is adapted to read XML and to write in Java Document Object Model structure.

4. The computation engine of claim 1 wherein the compilation component includes a lexical scanner and a code generator.

5. The computation engine of claim wherein the computation models are rate models pre-stored for access by the server component upon request over a network connection.

6. The computation engine of claim 1 wherein the model is a rate model designated as a user function to be embedded in another rate model.

7. The computation engine of claim 1 wherein the computation models are rate models and a knowledgebase configurator has access to the stored rate models through one of remote method invocation or through remote call procedure over a network connection.

8. The computation engine of claim 5 wherein the network connection is one of an Internet or an Intranet connection.

9. The computation engine of claim 7 wherein the network connection is one of an Internet or an Intranet connection.

10. The computation engine of claim 2 wherein the processing application can interpret Extensible Markup Language and can save data in the form of Extensible Markup Language.

11. A rating service comprising:
a procedural computation engine having a graphical user interface for creating procedural rating schemas; a parser for interpreting output from the graphical user interface; a compilation component for hierarchal node-structuring of data; and a server component for providing access to generated information;
a knowledgebase configurator for configuring service requests; and
a software interface application through which requests for rating are submitted;
characterized in that an end user accesses the configurator through the interface application and submits parameters for configuration of a service request whereupon the configurator calls the server component of the computation engine and selects a rate model from a pool of rate models that fits the request parameters, the rate model applied to and executed within the configuration model to produce the rating results through the application interface.

12. The rating service of claim 11 wherein the software interface application is an insurance application suite.

13. The rating service of claim 11 wherein the parser is adapted to read XML and to write in Java Document Object Model structure.

14. The rating service of claim 11 wherein the configurator is a Web-based configurator and calls the server component of the computation engine using one of remote method invocation or remote call procedure.

15. The rating service of claim 11 wherein a service configuration contains more than one rate model, the models individually executed according to optional scenarios.

16. The rating service of claim 11 wherein a service configuration contains more than one rate model, one rate model designated as a user function embedded in another rate model.

17. The rating service of claim 11 integrated with a software framework for enabling client security verification, user interface generation, workflow management, database search functionality, and language transformation for presentation to alternate platforms and interfaces.

18. A method for modeling a procedural rating schema comprising steps of
(a) using a spreadsheet interface, inputting at last one algorithm or formula into a specific cell or cells for rate calculation;
(b) in the same interface, entering the required input values into cells and marking the cells that will carry the input values into the calculation;
(c) in the same interface, marking the cell or cells that will show the output results from the calculation; and
(d) saving the data as a rating computation file in Extensible Markup Language.

19. The method of claim 18 wherein in step (a) the spreadsheet calculation functionality includes one or more calculation functions Loop Add, Loop Multiply, Loop And, Loop Or, and Loop Append.

20. The method of claim 18 including a step between step (a) and step (b) for inputting optional parameters for optional executions according to the differing parameters.

21. A method for compiling a rate model from a rate computation file created and saved in Extensible Markup Language comprising;
(a) parsing the file in a parser;
(b) building a symbol table from parsed elements;
(c) outputting a Java Document Object Model file from the parser;
(d) building a syntax tree from the Java Document Object Model file;
(e) validating the hierarchy of the syntax tree;
(f) generating model code for executing the file; and
(g) outputting the executable component.

22. The method of claim 22 wherein in step (a) the parser reads Extensible Markup Language and writes Java Document Object Model language.

23. The method of claim 22 wherein step (b) is referenced when step (d) is executing to access symbols from the symbol table.

24. The method of claim 22 further including a step between step (e) and step (f) for optimizing the built hierarchy.

25. The method of claim 22 further comprising a step between step (f) and step (g) for compiling the data into alternate object model languages for presentation across platforms.

26. The method of claim 18 wherein in step (a) the spreadsheet calculation functionality includes XML operation functions get value and set value.

27. The method of claim 21 wherein in step (d) the source node of the tree is a formula node with a condition variable of true or false.

28. The method of claim 26 wherein variables are scoped using block translation according to the condition type of true or false.

29. The computation engine of claim 4 wherein the compilation component includes at least one block translator for scoping variables.

30. The computation engine of claim 4 wherein the compilation component creates loop constructs to resolve variables in the case of a dynamic query, the loop calculations performed to create a formula.
